(19) United States
(12) Patent Application Publication
(10) Pub. No.: US 2024/0246805 A1
(43) Pub. Date: Jul. 25, 2024

(54) VENTING A CHAMBER IN A BEVERAGE CARBONATION SYSTEM

(71) Applicant: SharkNinja Operating LLC, Needham, MA (US)

(72) Inventors: Brandon J. Suleski, Cambridge, MA (US); Miles William Noel Hember, Cambridge (GB)

(21) Appl. No.: 18/099,690

(22) Filed: Jan. 20, 2023

(51) Int. Cl. B67D 1/00; A23L 2/54; B01F 23/236; B01F 23/237; B01F 35/00

(52) U.S. Cl. CPC B67D 1/0075; A23L 2/54; B01F 23/2362; B01F 23/2363; B01F 23/237621; B01F 35/189; B01F 2101/14

(57) ABSTRACT

Various systems, devices, and methods of venting a chamber in a beverage carbonation system are provided. A carbonation system is one example of a treatment system to which the systems, devices, and methods described herein apply. In general, a carbonation system can include a venting system configured to vent a mixing chamber of the carbonation system in which a carbonated fluid is configured to be formed. The venting system can be configured to provide flow restriction configured to provide a restriction on a vent flow path through which the mixing chamber is vented.

### FIELD

The present disclosure generally relates to beverage carbonation systems.

### BACKGROUND

Various beverage carbonation systems are available that dispense carbonated beverages, for example, carbonated water. In some instances, the carbonated water can be flavored. Such beverage carbonation systems can be used in various locations by consumers, such as in homes or offices, to carbonate liquid and dispense the carbonated fluid into a container on demand.

Beverage carbonation systems can provide the carbonated fluid by mixing in a mixing chamber carbon dioxide (CO₂) gas with water to dissolve the CO₂ in the water. The dissolution takes place at a significantly elevated pressure to reach the required concentration of dissolved CO₂. The carbonated fluid thereafter exits the mixing chamber for dispensing to a user. However, a pressure within the mixing chamber cannot be too high when the carbonated fluid begins to be dispensed or the pressure in the mixing chamber will cause the carbonated fluid to exit the mixing chamber at too high a rate such that the carbonated fluid will spray out of the carbonation system and cause messy splatter and/or cause at least some of the carbonated fluid to not be neatly dispensed into the container.

The CO₂ can be supplied to the mixing chamber from a pressurized CO₂ canister removably coupled to the carbonation system. Each time a carbonated fluid is formed, CO₂ is supplied from the canister to the mixing chamber, so an amount of CO₂ in the canister decreases. At some point the canister must be replaced so that a sufficient amount of CO₂ is available to form carbonated beverages with a satisfactory amount of carbonation. However, it is difficult for a user to know when a canister's CO₂ level becomes low because CO₂ canisters for carbonation systems typically do not include any indication of a current amount of CO₂ contained therein. Some systems include flow meters or weighing apparatuses to determine CO₂ level, but flow meters and weighing apparatuses are relatively expensive components and thus add cost to the system, as well as components that occupy valuable real estate in a carbonation system. The user may therefore not know when to order a new CO₂ canister to have on hand ready for use and/or when to replace a CO₂ canister currently coupled to a carbonation system.

Additionally, only a certain amount of CO₂ is supplied from the canister to the mixing chamber for each carbonated fluid to be formed. The canister therefore only needs to be open at certain times to release CO₂ therefrom, e.g., times when CO₂ is being supplied to the mixing chamber to form a carbonated fluid. However, the CO₂ contained in the canister is at a high pressure. Thus, if the canister is always open to allow CO₂ to exit from the canister when needed, a risk exists that high pressure from the CO₂ canister may be introduced unintentionally into the carbonation system, which may severely damage the system.

Accordingly, there remains a need for improved devices, systems, and methods for carbonation systems.

### SUMMARY

In general, systems, devices, and methods for a beverage carbonation system are provided.

In one aspect, a system is provided that in one embodiment includes a chamber configured to receive a liquid and a pressurized gas therein that are mixed together in the chamber to form a treated fluid, one or more vents operatively coupled to the chamber and configured to move from a closed position to an open position so as to allow pressure in the chamber to be released through the one or more vents, and a processor configured to control movement of the one or more vents between the closed position and the open position such that the release of the pressure occurs in a first venting period, in which flow is restricted through the one or more vents, and then in a second venting period, in which flow is not restricted through the one or more vents.

The system can have any number of variations. For example, the one or more vents can include a first vent and a second vent. Further, the system can include a flow restrictor configured to be in fluid communication with the first vent and not be in fluid communication with the second vent; and/or venting of the chamber can occur through only one of the first and second vents at a time. Further, the processor can be configured to control movement of the first vent and the second vent such that, in the first venting period, venting of the chamber occurs through the first vent and the flow restrictor, and in the second venting period, venting of the chamber occurs through the second vent; and/or the flow restrictor can include tubing having a diameter that is less than tubing in fluid communication with the second vent. Further, in the first venting period venting of the chamber can not occur through the second vent, and in the second venting period venting of the chamber can not occur through the first vent or the flow restrictor.

For another example, the one or more vents can include a single vent. Further, the processor can be configured to control movement of the single vent such that, in the first venting period, the single vent is repeatedly opened and closed, and in the second venting period, the single vent remains open continuously.

For yet another example, the venting can occur after the treated fluid has been formed in the chamber.

For another example, the system can also include a liquid source configured to supply the liquid to the chamber, and a gas source configured to supply the gas to the chamber.

For still another example, the gas can be carbon dioxide, and the treated fluid can be a carbonated fluid.

In another embodiment, a system includes a processor configured to determine an amount of pressurized CO₂ released from a CO₂ source for use by a carbonation system in forming a single carbonated fluid, determine a current total amount of pressurized CO₂ remaining in the CO₂ source based at least in part on the determined amount of pressurized CO₂, and cause a notification to be provided to a user of the carbonation system that is indicative of the current total amount of pressurized CO₂ remaining in the CO₂ source.

The system can have any number of variations. For example, determining the amount of pressurized CO₂ released from the CO₂ source can include using a lookup table, and the lookup table can correlate amounts of released CO₂ to at least one of carbonated fluid carbonation level, carbonated fluid volume, liquid temperature, and duration of CO₂ supplied.

For another example, determining the total amount of pressurized CO₂ remaining in the CO₂ source can include one of: subtracting the amount of pressurized CO₂ released from the gas source from a total amount of pressurized CO₂ in the CO₂ source prior to the release of the amount of pressurized CO₂, and adding the amount of pressurized CO₂ released from the gas source to a total amount of pressurized CO₂ in the CO₂ source prior to the release of the amount of pressurized CO₂.

For yet another example, the processor can be configured to determine if the determined total amount of pressurized CO₂ remaining in the CO₂ source is below a threshold amount, and the processor can be configured to provide the notification only if the determined total amount of pressurized CO₂ remaining in the CO₂ source is below the threshold amount. Further, the threshold amount can correspond to an amount of CO₂ remaining in the CO₂ source where, after a certain number of carbonated fluids are formed by the carbonation system using CO₂ from the CO₂ source, carbonation quality of carbonated fluid formed by the carbonation system will be degraded, and/or the threshold amount can be based on a remaining number of carbonated fluids that the carbonation system can form using CO₂ from the CO₂ source. Further, the remaining number can be based on at least one of carbonated fluid volume, carbonated fluid carbonation level, temperature of liquid mixed with the gas, and duration of CO₂ supplied.

For another example, the notification can be configured to be continuously provided to the user.

For yet another example, the notification can include at least one of a visual notification and an audible notification.

For still another example, the notification can be provided to the user via at least one of a user interface of the carbonation system and a user interface of an external device.

For another example, the processor can be configured to determine the amount of pressurized CO₂ released from the CO₂ source in response to receiving a signal indicative of a start of a process of the carbonation system forming the single carbonated fluid. Further, the processor can be configured to determine the amount of pressurized CO₂ released from the CO₂ source before the pressurized CO₂ is released from the CO₂ source or after the pressurized CO₂ has been released from the CO₂ source.

For yet another example, the system can include the CO₂ source containing pressurized CO₂ therein.

In another embodiment, a system includes a CO₂ source containing pressurized CO₂ therein and including a pin configured to move between a first position and a second position. The pressurization biases the pin to the first position. The system also includes a motor, and a cam configured to be driven by the motor to move in a first direction relative to the CO₂ source and thereby move the pin from the first position to the second position. The cam is also configured to be driven by the motor to move in a second direction, opposite to the first direction, relative to the CO₂ source and thereby move the pin from the second position to the first position. The pin being in the first position corresponds to the CO₂ source being closed such that the CO₂ contained therein cannot be released from the CO₂ source, the pin being in the second position corresponds to the CO₂ source being open such that the CO₂ contained therein can be released from the CO₂ source, and the CO₂ released from the CO₂ source is configured to be used by a carbonation system in forming a carbonated fluid.

The system can vary in any number of ways. For example, the pin can be configured such that a top surface of the pinslides along the cam during the movement of the cam relative to the CO₂ source.

For another example, the cam can have a tapered shape in which a first terminal end of the cam is wider than a second terminal end of the cam, the pin in the first position can engage the first terminal end of the cam, and the pin in the second position can engage the second terminal end of the cam.

For yet another example, the cam can be formed in a drive member operably coupled to the motor. Further, the system can also include a gear train that operably couples the motor and the drive member, and the cam can be configured to be driven by the motor driving the gear train.

For still another example, the system can also include a processor operably coupled to the motor, the processor can be configured to transmit a first control signal to the motor that causes the motor to drive the cam's movement in the first direction, and the processor can be configured to transmit a second control signal to the motor that causes the motor to drive the cam's movement in the second direction. Further, the processor can be configured to transmit the second control signal to the motor a predetermined amount of time after the processor has transmitted the first control signal to the motor; the processor can be configured to receive a signal indicative of a start of a process of forming the carbonated fluid, and the processor can be configured to transmit the first control signal to the motor in response to the receipt of the signal indicative of the start of the process of forming the carbonated fluid; and/or the system can also include a first switch operably coupled with the processor, the system can also include a second switch operably coupled with the processor, the system can also include a gear configured to be driven by the motor to move between a first position, in which the gear is engaged with the first switch and is not engaged with the second switch, and a second position, in which the gear is engaged with the second switch and is not engaged with the first switch, the gear becoming engaged with the first switch can be configured to cause the processor to transmit the first control signal, and the gear becoming engaged with the second switch can be configured to cause the processor to transmit the second control signal. Further, the processor can receive the signal from a user interface of the carbonation system, or the processor can receive the signal from an external device.

For another example, the system can also include a liquid source that contains a liquid therein, and a mixing chamber in which the carbonation system is configured to mix liquid from the liquid source and CO₂ from the CO₂ source to form the carbonated fluid.

In another embodiment, a system includes a motor. The system also includes a CO₂ source containing pressurized CO₂ therein and being configured to move from being closed, in which CO₂ cannot be released from the CO₂ source, to being open, in which the CO₂ can be released from the CO₂ source and used in forming a carbonated fluid. The system also includes a drive member operably coupled to the motor and to the CO₂ source, and a processor configured to transmit a first control signal to the motor that causes the motor to drive rotation of the drive member in a first direction, thereby causing the CO₂ source to move from being closed to being open, and the processor being configured to transmit a second control signal to the motor that causes the motor to drive rotation of the drive member in a second, opposite direction, thereby causing the CO₂ source to move from being open to being closed.

The system can have any number of variations. For example, the CO₂ source can include a pin configured to move between a first position and a second position, the pressurized CO₂ contained in the CO₂ source can bias the pin to the first position, the CO₂ source can be closed with the pin in the first position, the CO₂ source can be open with the pin in the second position, the drive member rotating in the first direction can push on the pin to force the pin to move from the first position to the second position, and the drive member rotating in the second direction can allow the pin to automatically move from the second position to the first position. Further, the drive member can include a cam engaged with the pin, and the rotation of the drive member can be configured to cause a top surface of the pin to slide along the cam. Further, the cam can have a tapered shape in which a first terminal end of the cam is wider than a second terminal end of the cam, the pin in the first position can engage the first terminal end of the cam, and the pin in the second position can engage the second terminal end of the cam.

For yet another example, the system can also include a gear train that operably couples the motor and the drive member, and the drive member can be configured to rotate by the motor driving the gear train.

For still another example, the processor can be configured to receive a signal indicative of a start of a process of forming a carbonated fluid, and the processor can be configured to transmit the first control signal to the motor in response to the receipt of the signal indicative of the start of the process of forming the carbonated fluid. Further, the processor can receive the signal from a user interface of the carbonation system, or the processor can receive the signal from an external device.

For another example, the system can also include a first switch operably coupled with the processor, the system can also include a second switch operably coupled with the processor, the system can also include a gear configured to be driven by the motor to move between a first position, in which the gear is engaged with the first switch and is not engaged with the second switch, and a second position, in which the gear is engaged with the second switch and is not engaged with the first switch, the gear becoming engaged with the first switch can be configured to cause the processor to transmit the first control signal, and the gear becoming engaged with the second switch can be configured to cause the processor to transmit the second control signal.

For still another example, the system can include a liquid source that contains a liquid therein, and a mixing chamber in which a carbonation system is configured to mix liquid from the liquid source and CO₂ from the CO₂ source to form the carbonated fluid.

In another aspect, a method is provided that in one embodiment includes forming a treated fluid in a chamber by mixing together a liquid and a gas under pressure, and, after forming the treated fluid, controlling, using a processor, movement of one or more vents between a closed position and an open position such that release of pressure in the chamber occurs in a first venting period, in which flow is restricted through the one or more vents, and then in a second venting period, in which flow is not restricted through the one or more vents.

The method can have any number of variations. For example, the one or more vents can include a first vent and a second vent. Further, a flow restrictor can be in fluid communication with the first vent and not be in fluid communication with the second vent, and/or venting of the chamber can occur through only one of the first and second vents at a time. Further, the processor can control movement of the first vent and the second vent such that, in the first venting period, venting of the chamber occurs through the first vent and the flow restrictor, and in the second venting period, venting of the chamber occurs through the second vent; and/or the flow restrictor can include tubing having a diameter that is less than tubing in fluid communication with the second vent. Further, in the first venting period venting of the chamber can not occur through the second vent, and in the second venting period venting of the chamber can not occur through the first vent or the flow restrictor.

For another example, the one or more vents can include a single vent. Further, the processor can control movement of the single vent such that, in the first venting period, the single vent is repeatedly opened and closed, and in the second venting period, the single vent remains open continuously.

For yet another example, forming the treated fluid can include agitating the liquid and a pressurized gas using an agitator rotating within the chamber.

For still another example, the method can also include supplying the liquid to the chamber from a liquid source, and supplying the gas to the chamber from a gas source.

For another example, the gas can be carbon dioxide, and the treated fluid can be a carbonated fluid.

In another embodiment, a method includes forming a treated fluid in a chamber by mixing together a liquid and a gas under pressure, and, after forming the treated fluid, controlling, using a processor, venting of pressure from the chamber such that after a predetermined period of time passes from an end of the mixing together of the liquid and the gas, starting to vent the chamber at a first rate of pressure release in a first venting period and, thereafter, venting the chamber at a second, higher rate of pressure release in a second venting period.

The method can vary in any number of ways. For example, the processor controlling the venting of pressure can include the processor controlling opening and closing of at least one vent through which pressure is released from the chamber. In some embodiments, the at least one vent can include a first vent and a second vent. Further, a flow restrictor can be in fluid communication with the first vent and not be in fluid communication with the second vent, and/or venting of pressure from the chamber can occur through only one of the first and second vents at a time. Further, the processor can control movement of the first vent and the second vent such that, in the first venting period, venting of the chamber occurs through the first vent and the flow restrictor, and in the second venting period, venting of the chamber occurs through the second vent; and/or the flow restrictor can include tubing having a diameter that is less than tubing in fluid communication with the second vent. Further, in the first venting period venting of the chamber can not occur through the second vent, and in the second venting period venting of the chamber can not occur through the first vent or the flow restrictor. In some embodiments, the at least one vent can include a single vent. Further, the processor can control opening and closing of the single vent such that, in the first venting period, the single vent is repeatedly opened and closed, and in the second venting period, the single vent remains open continuously.

For yet another example, forming the treated fluid can include agitating the liquid and a pressurized gas using an agitator rotating within the chamber.

For still another example, the method can also include supplying the liquid to the chamber from a liquid source, and supplying the gas to the chamber from a gas source.

For another example, the gas can be carbon dioxide, and the treated fluid can be a carbonated fluid.

In another embodiment, a method includes determining, using a processor of a carbonation system, an amount of pressurized CO₂ supplied from a CO₂ source to a mixing chamber of a carbonation system to form a single carbonated fluid. The method also includes determining, using the processor, a total amount of pressurized CO₂ remaining in the CO₂ source after the amount of pressurized CO₂ has been supplied. The method also includes causing, using the processor, a notification to be provided to a user of the carbonation system that is indicative of the total amount of pressurized CO₂ remaining in the CO₂ source.

The method can have any number of variations. For example, determining the amount of pressurized CO₂ can include using a lookup table, and the lookup table can correlate amounts of CO₂ released to at least one of carbonated fluid carbonation level, carbonated fluid volume, and liquid temperature.

For another example, determining the total amount of pressurized CO₂ remaining in the CO₂ source can include one of: subtracting the amount of pressurized CO₂ released from the gas source from a total amount of pressurized CO₂ in the CO₂ source prior to the supplying of the amount of pressurized CO₂, and adding the amount of pressurized CO₂ released from the gas source to a total amount of pressurized CO₂ in the CO₂ source prior to the supplying of the amount of pressurized CO₂.

For yet another example, the method can also include determining, using the processor, if the determined total amount of pressurized CO₂ remaining in the CO₂ source is below a threshold amount, and the notification can be provided only if the determined total amount of pressurized CO₂ remaining in the CO₂ source is below the threshold amount. Further, the threshold amount can correspond to an amount of CO₂ remaining in the CO₂ source where, after a certain number of carbonated fluids are formed by the carbonation system using CO₂ from the CO₂ source, carbonation quality of carbonated fluid formed by the carbonation system will be degraded, and/or the threshold amount can be based on a remaining number of carbonated fluids that the carbonation system can form using CO₂ from the CO₂ source. Further, the remaining number can be based on at least one of carbonated fluid volume, carbonated fluid carbonation level, and temperature of liquid mixed with the gas.

For still another example, the notification can be configured to be continuously provided to the user.

For another example, the notification can include at least one of a visual notification and an audible notification.

For yet another example, the notification can be provided to the user via at least one of a user interface of the carbonation system and a user interface of an external device.

For another example, the processor can determine the amount of pressurized CO₂ supplied from the CO₂ source in response to receiving a signal indicative of a start of a process of the carbonation system forming the single carbonated fluid. Further, the processor can be configured to determine the amount of pressurized CO₂ released from the CO₂ source before the pressurized CO₂ is released from the CO₂ source or after the pressurized CO₂ has been released from the CO₂ source.

In another embodiment, a method includes transmitting a first control signal from a processor to a motor that causes the motor to drive rotation of a drive member in a first direction, thereby causing a CO₂ source to move from being closed to being open such that pressurized CO₂ contained in the CO₂ source is released from the CO₂ source for use in forming a carbonated fluid, and transmitting a second control signal to the motor that causes the motor to drive rotation of the drive member in a second, opposite direction, thereby causing the CO₂ source to move from being open to being closed.

The method can vary in any number of ways. For example, the rotation of the drive member in the first direction can cause a cam of the drive member to push down a pin of the CO₂ source and counteract force applied to the pin by the pressurized CO₂ contained in the CO₂ source, and the rotation of the drive member in the second direction can allow the pin to automatically move up. Further, the rotation of the drive member can cause the pin to slide along a cam of the drive member. Further, the cam can have a tapered shape in which a first terminal end of the cam is wider than a second terminal end of the cam, the rotation of the drive member in the first direction can cause the pin to slide along the cam toward the second terminal end of the cam, and the rotation of the drive member in the second direction can cause the pin to slide along the cam toward the first terminal end of the cam.

For another example, the method can also include receiving, at the processor, a signal indicative of a start of a process of forming the carbonated fluid, and the processor can transmit the first control signal to the motor in response to the receipt of the signal indicative of the start of the process of forming the carbonated fluid. Further, the processor can receive the signal from a user interface of the carbonation system, or the processor can receive the signal from an external device.

For yet another example, the motor driving rotation of the drive member can include the motor driving rotation of a gear, the gear can be configured to move between a first position, in which the gear is engaged with a first switch and is not engaged with a second switch, and a second position, in which the gear is engaged with the second switch and is not engaged with the first switch, the gear becoming engaged with the first switch can be configured to cause the processor to transmit the first control signal, and the gear becoming engaged with the second switch can be configured to cause the processor to transmit the second control signal.

For another example, the method can also include triggering, using the processor, the carbonated fluid to be formed by mixing liquid released from a liquid source and the CO₂ released from the CO₂ source.

### BRIEF DESCRIPTION OF DRAWINGS

This disclosure will be more fully understood from the following detailed description taken in conjunction with the accompanying drawings, in which:

FIG. 1 is a schematic view of one embodiment of a carbonation system;

FIG. 2 is a schematic view of another embodiment of a carbonation system;

FIG. 3 is a schematic view of yet another embodiment of a carbonation system;

FIG. 4 is a schematic view of still another embodiment of a carbonation system;

FIG. 5A is a partial perspective view of another embodiment of a carbonation system;

FIG. 5B is another perspective view of the carbonation system of FIG. 5A;

FIG. 6A is a front view of another embodiment of a carbonation system;

FIG. 6B is a partial perspective view of the carbonation system of FIG. 6A;

FIG. 7A is a perspective view of another embodiment of a carbonation system;

FIG. 7B is a perspective view of the carbonation system of FIG. 7A with a gas source chamber cover removed therefrom and with a liquid source released therefrom;

FIG. 7C is a perspective view of the carbonation system of FIG. 7B with a gas source removed from the gas source chamber;

FIG. 7D is a perspective view of the gas source of FIG. 7C;

FIG. 7E is a perspective view of a portion of the carbonation system of FIG. 7A;

FIG. 7F is a perspective view of another portion of the carbonation system of FIG. 7A;

FIG. 7G is a cross-sectional view of a portion of the carbonation system of FIG. 7A;

FIG. 7H is a cross-sectional view of another portion of the carbonation system of FIG. 7A;

FIG. 7I is a perspective view of another portion of the carbonation system of FIG. 7A;

FIG. 7J is a perspective view of yet another portion of the carbonation system of FIG. 7A;

FIG. 7K is a perspective view of a drive member of the carbonation system of FIG. 7A;

FIG. 7L is another perspective view of the drive member of FIG. 7K;

FIG. 7M is a perspective view of a gear of the carbonation system of FIG. 7A;

FIG. 7N is a perspective view of a partial portion of the carbonation system of FIG. 7A;

FIG. 7O is a schematic view of the carbonation system of FIG. 7A; communicatively coupled with an external device;

FIG. 8 is a flowchart of one embodiment of a method of selectively activating release of CO₂ from a gas source;

FIG. 9 is flowchart of one embodiment of a method of determining an amount of CO₂ in a gas source;

FIG. 10 is a graph plotting chamber pressure versus time;

FIG. 11 is a schematic view of another embodiment of a carbonation system; and

FIG. 12 is a schematic view of yet another embodiment of a carbonation system.

### DETAILED DESCRIPTION

Certain embodiments will now be described to provide an overall understanding of the principles of the structure, function, manufacture, and use of the devices, systems, and methods disclosed herein. One or more examples of these embodiments are illustrated in the accompanying drawings. Those skilled in the art will understand that the devices, systems, and methods specifically described herein and illustrated in the accompanying drawings are non-limiting embodiments and that the scope of the present invention is defined solely by the claims. The features illustrated or described in connection with one exemplary embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape.

Various illustrative systems, devices, and methods for a beverage carbonation system are provided. In general, a carbonation system is configured to form a carbonated fluid and dispense the carbonated fluid into a container, such as a bottle, a cup, or other container.

The systems, devices, and methods described herein are not limited to carbonation systems in which a liquid is mixed with CO₂ to form a treated fluid in the form of a carbonated fluid intended to be a beverage. A beverage carbonation system is one example of a treatment system to which the systems, devices, and methods described herein apply. Other treatment systems are generally configured and used similar to the carbonation systems described herein except instead of mixing CO₂ with a liquid, a different gas is mixed with the liquid. The resulting fluid is a treated fluid but is not a “carbonated” fluid.

### Carbonation Systems

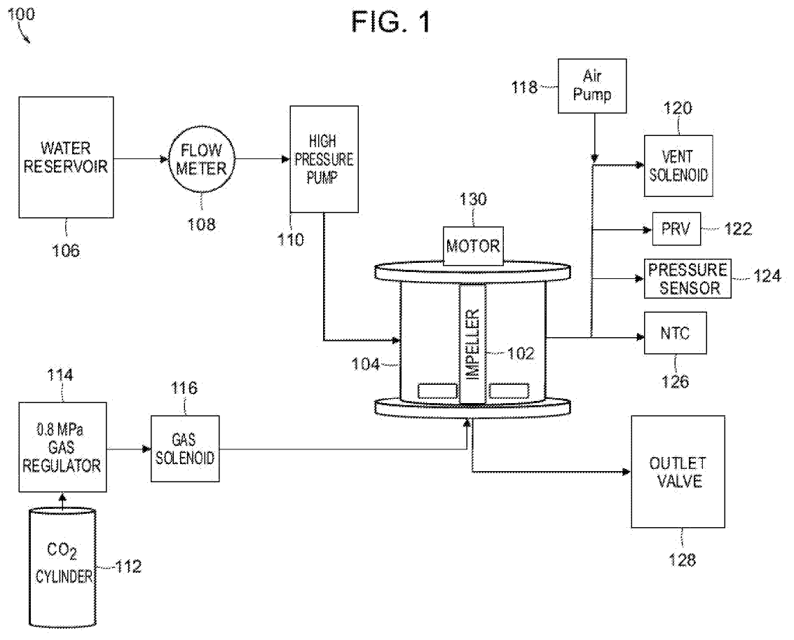

FIG. 1 illustrates one embodiment of a carbonation system 100 configured to form a carbonated fluid. The carbonation system 100 of this illustrated embodiment includes an agitator (labelled “impeller” in FIG. 1) 102 and includes a mixing chamber 104 in which the agitator 102 is disposed and configured to rotate to form the carbonated fluid. Various embodiments of agitators and chambers are described, for example, in Intl. Pat. App. No. PCT/CN2022/092688 entitled “Agitator For A Carbonation System” filed May 13, 2022, which is hereby incorporated by reference in its entirety.

The carbonation system 100 also includes a liquid source (also referred to herein as a “liquid reservoir”) 106 configured to be a source of liquid for mixing in the chamber 104, a flow meter 108 configured to regulate an amount of liquid that flows from the liquid source 106 to the chamber 104, and a high pressure pump 110 configured to pump liquid from the liquid source 106 to the chamber 104. The liquid is water in this illustrated embodiment such that the liquid source 106 is a water reservoir, but another liquid can be used, such as juice. The pump for liquid is a high pressure pump 110 in this illustrated example but can be another type of pump, such as a low pressure, high flow rate pump.

The carbonation system 100 also includes a gas source 112 configured to be a source of gas for mixing in the chamber 104, a gas regulator 114 configured to regulate an amount of gas that flows from the gas source 112 to the chamber 104, and a gas solenoid valve 116 configured to open and close to selectively allow the gas to flow from the gas source 112 to the chamber 104. The gas is CO₂ in this illustrated embodiment such that the gas source 112 is a CO₂ source in the form of a CO₂ cylinder (also referred to herein as a “CO₂ canister”), but another gas can be used (in which case, as mentioned above, the fluid dispensed would not be a “carbonated” fluid but would be a treated fluid). The gas regulator 114 is an 0.8 MPa gas regulator in this illustrated embodiment but other gas regulators can be used. For example, the gas regulator 114 can be a 0.65 MPa gas regulator. The gas regulator 114 can be configured to allow a high flow rate of gas when it is open so that the operation of the process takes less time as compared to use of a low flow rate of gas. As discussed herein, the carbonation system 100 can be configured to determine an amount of gas in the gas source 112 and to trigger an alert to be provided to a user indicating that the amount of gas in the gas source 112 has reached a predetermined threshold level. As also discussed herein, the carbonation system 100 can be configured to selectively open the gas source 112 to supply gas to the mixing chamber 104 on demand for a beverage formation and dispensing process.

The carbonation system 100 also includes an air pump 118 configured to drive a flow of the carbonated fluid out of the chamber 104 through an outlet valve 128. The outlet valve 128 is configured to selectively open to allow the carbonated fluid to exit the chamber 104 and out of the carbonation system 100, e.g., for dispensing into a container such as a cup, a bottle, etc. The outlet valve 128 can be of a type that allows modulation of the flow passage through the outlet valve 128 such that the outlet valve 128 can be used as a control element configured to manage the flow rate. In particular, the opening of the outlet valve 128 can be configured to avoid creating a sudden jet or burst of flow at the start of dispensing. The air pump 118 is configured to pump air into the chamber 104 such that, with the outlet valve 128 open, the carbonated fluid in the chamber 104 is forced out of the chamber 104 and out of the carbonation system 100 through the outlet valve 128.

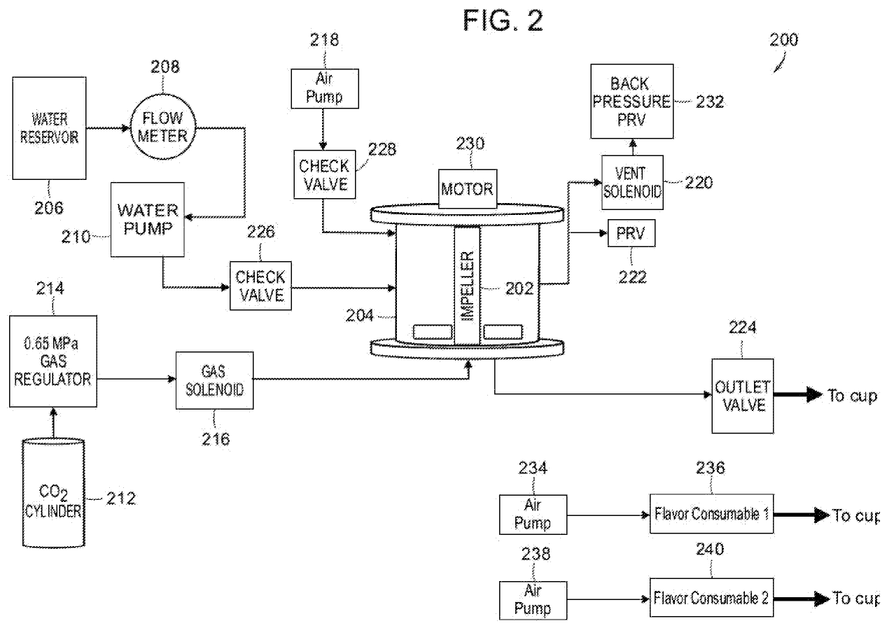

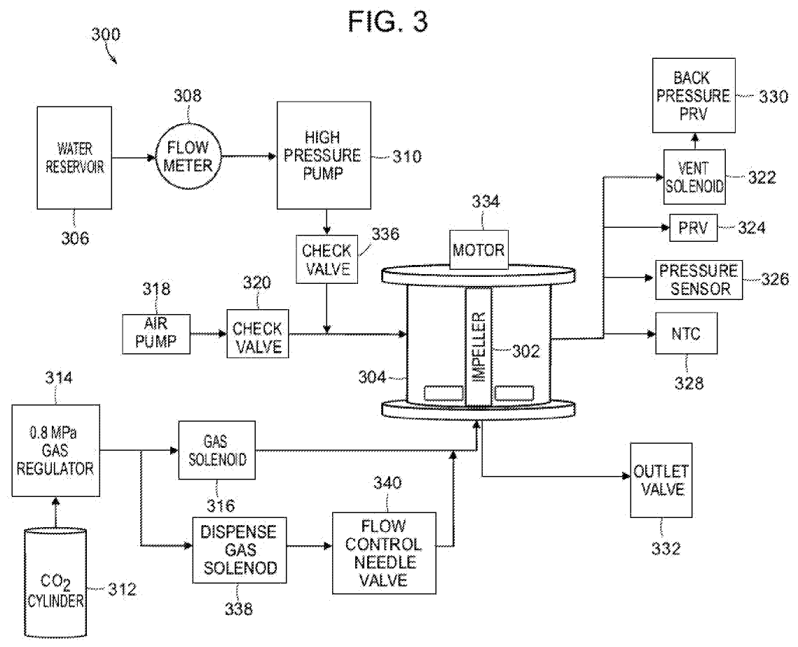

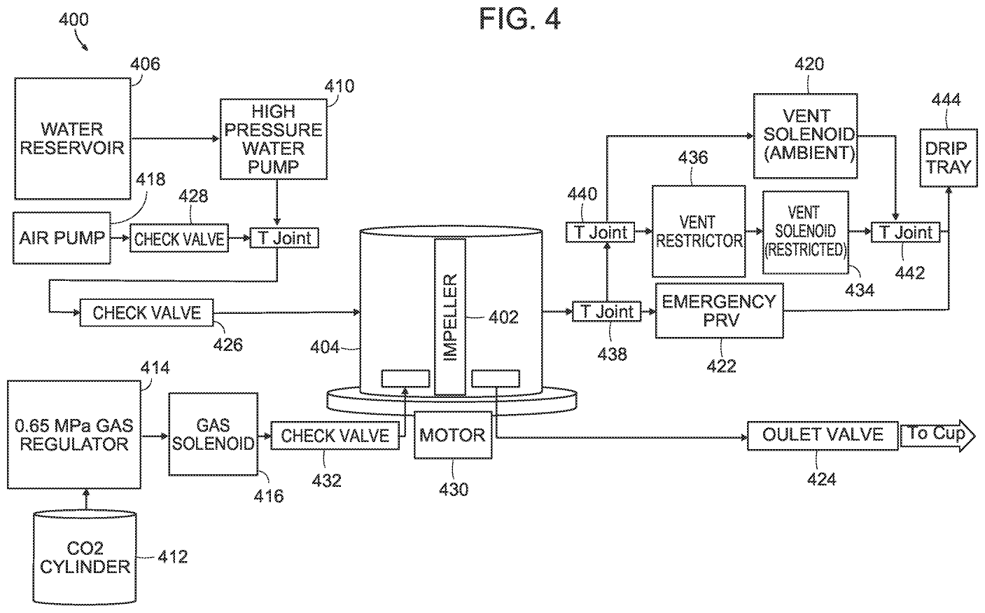

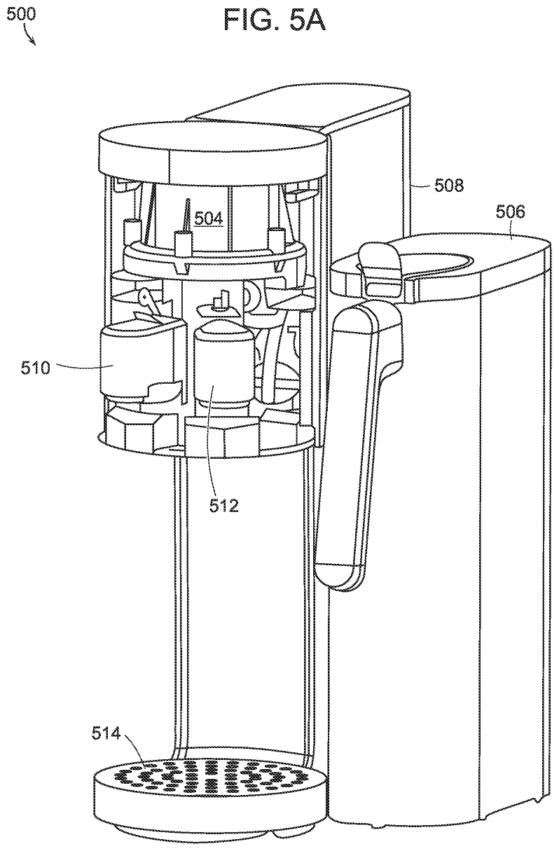

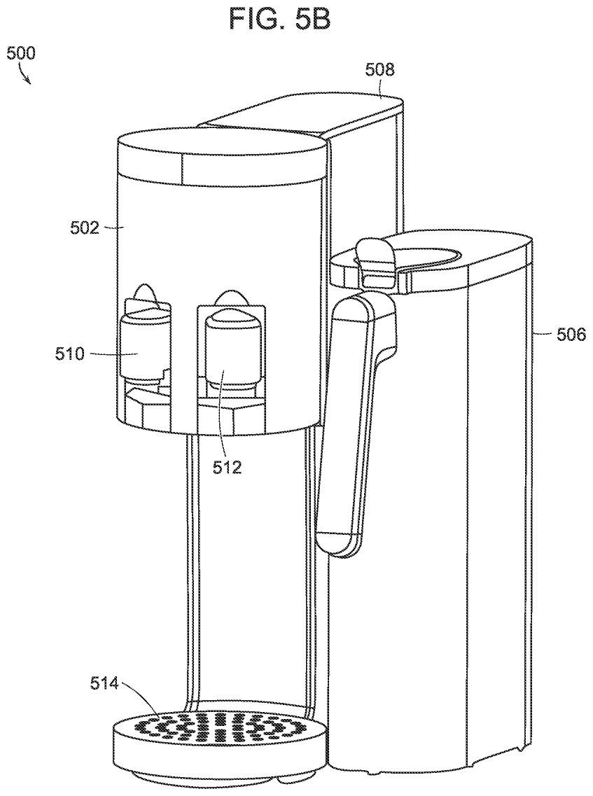

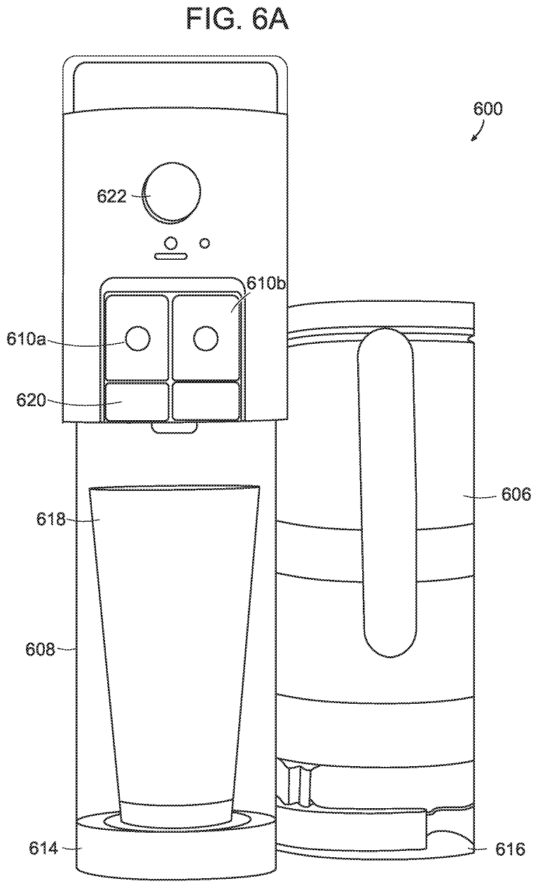

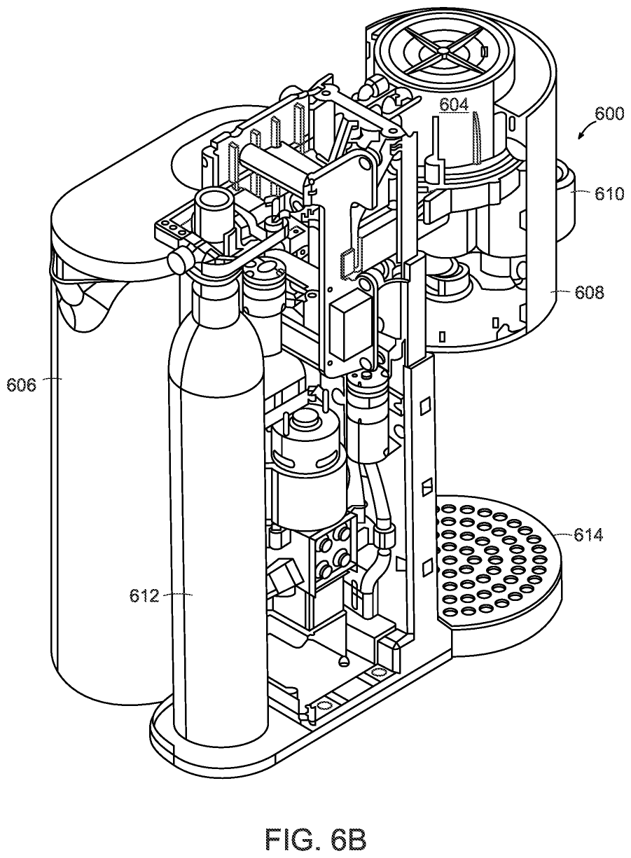

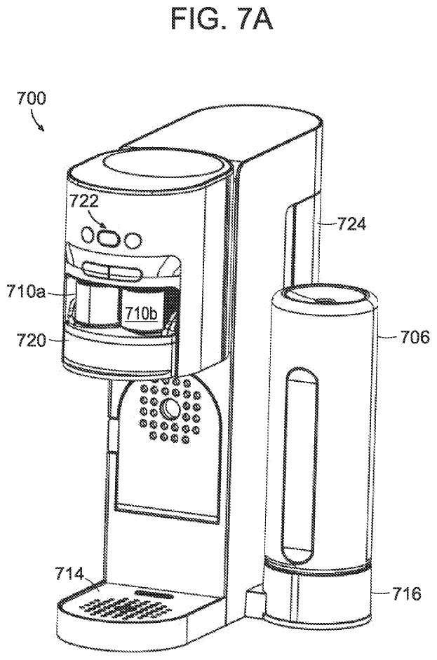

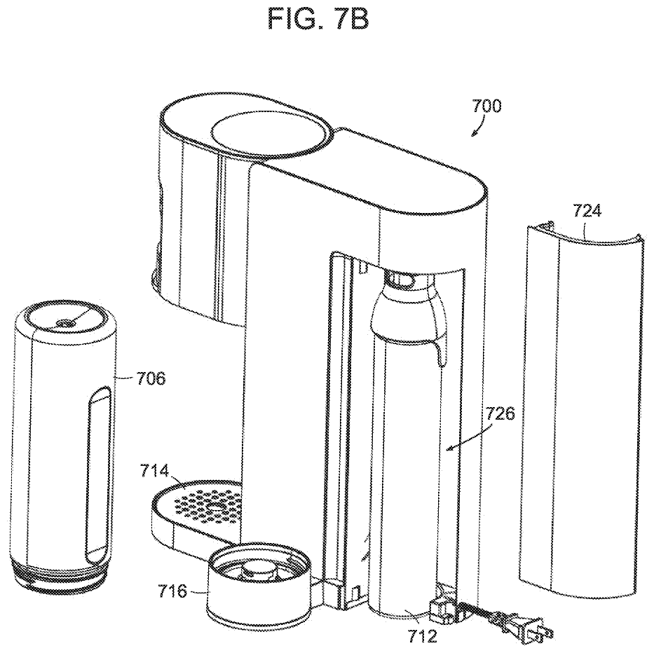

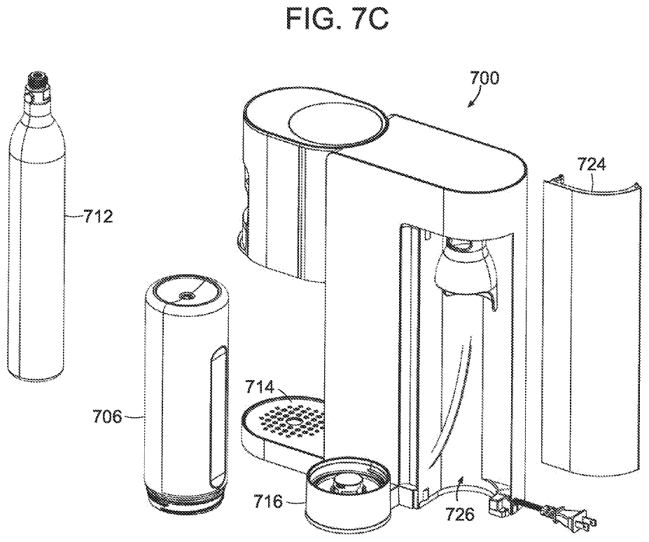

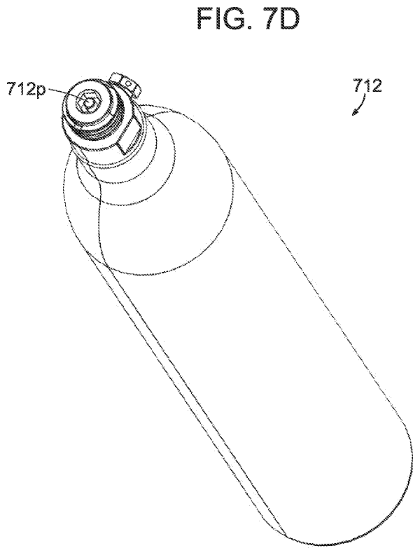

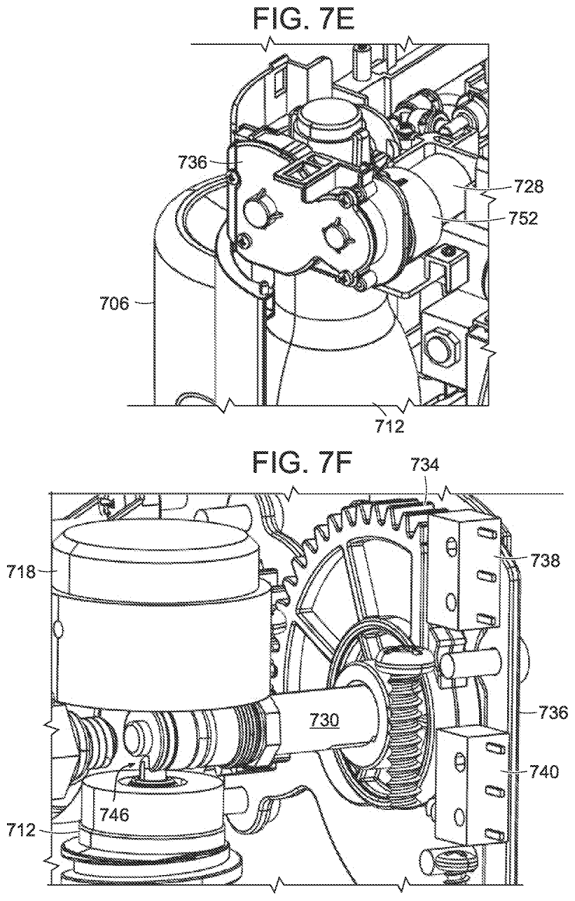

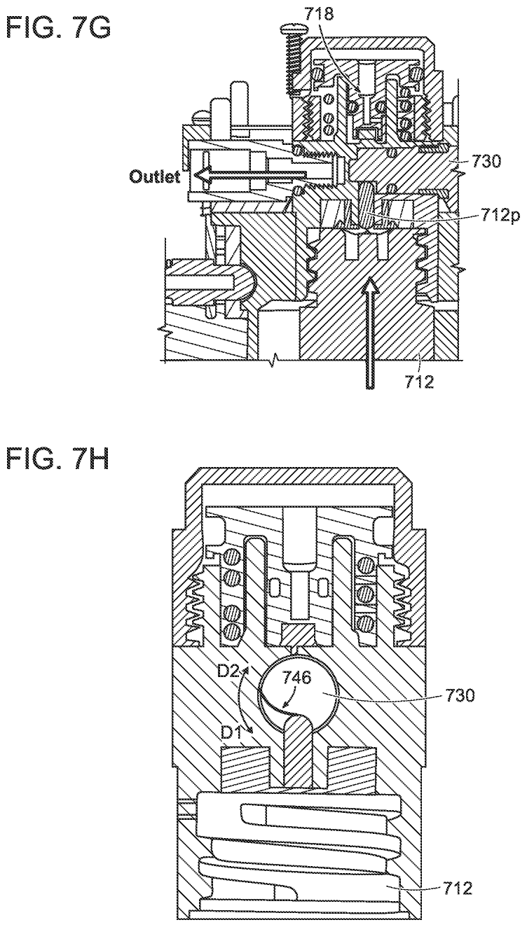

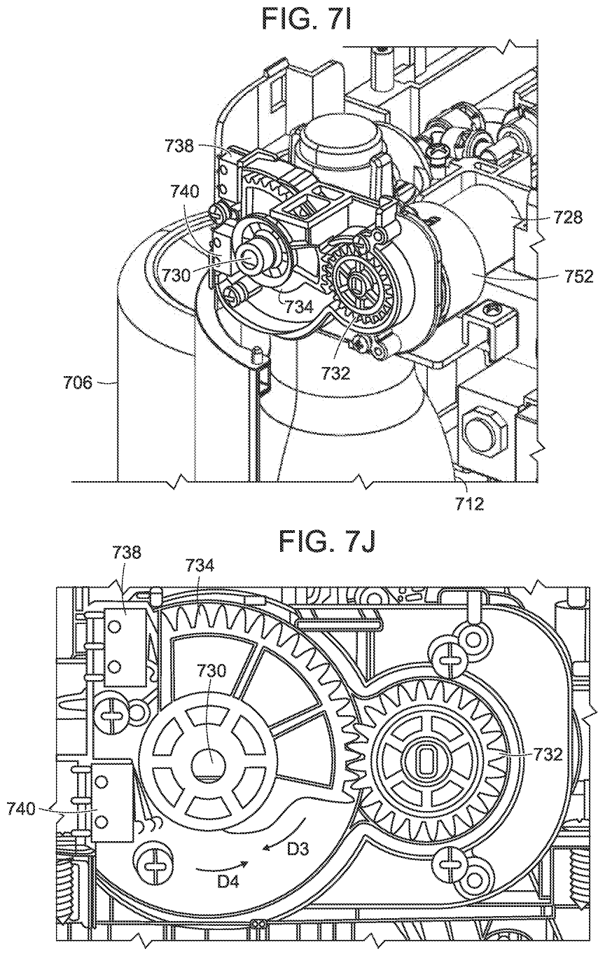

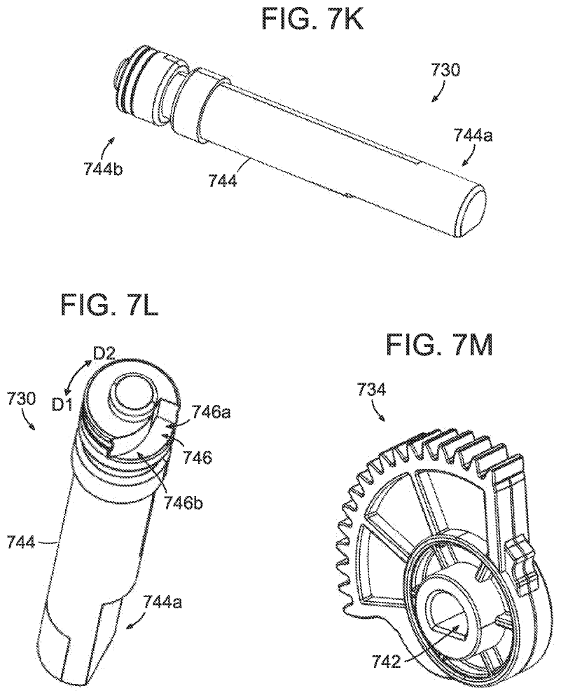

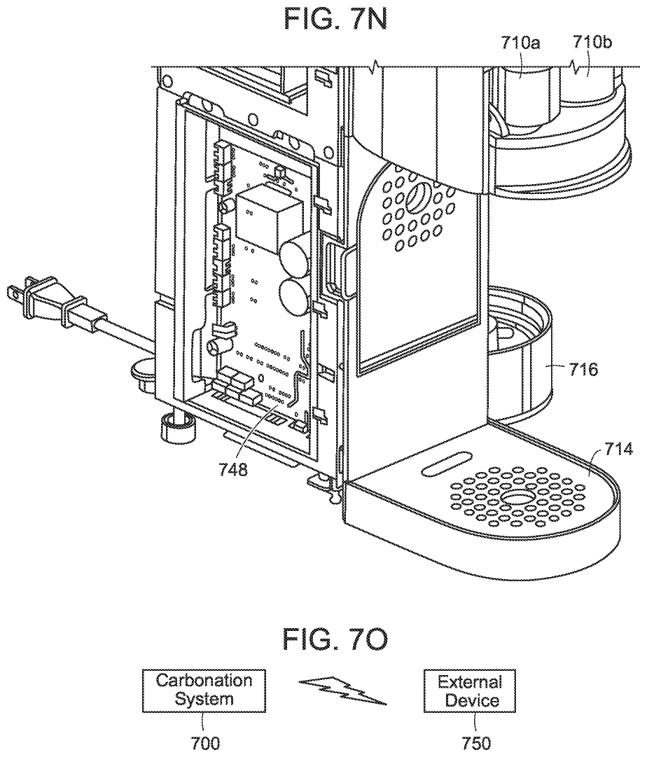

In some embodiments, a pressure within the chamber 104 in combination with resistance of an output channel can be configured to drive a flow of the carbonated fluid out of the chamber 104 through the outlet valve 128 before the air pump 118 is actuated to pump air into the chamber 104. Various embodiments of such flow control are described, for example, in U.S. patent application Ser. No. 17/821,212 entitled “Beverage Carbonation System Flow Control” filed Aug. 22, 2022, which is hereby incorporated by reference in its entirety. The various embodiments of carbonation systems (e.g., the carbonation system 100 of FIG. 1, a carbonation system 200 of FIG. 2, a carbonation system 300 of FIG. 3, a carbonation system 400 of FIG. 4, a carbonation system 500 of FIGS. 5A and 5B, a carbonation system 600 of FIGS. 6A and 6B, a carbonation system 700 of FIGS. 7A-7C, etc.) described herein can include such flow control.

The carbonation system 100 also includes a vent solenoid valve 120 configured to allow excess pressure to be released from the chamber 104 with the vent solenoid valve 120 open, a pressure relief valve (PRV) 122, a pressure sensor 124 configured to measure pressure in the chamber 104, and a temperature sensor 126 configured to measure temperature in the chamber 104. The temperature sensor 126 may be a negative temperature coefficient (NTC) thermistor as in this illustrated embodiment, but another type of temperature sensor can be used. In some embodiments, the temperature sensor 126 is omitted.

The carbonation system 100 may also include a motor 130 configured to drive the rotation of the agitator 102. The motor 130 is shown disposed outside of and above the chamber 104 in this illustrated embodiment but a first portion of the motor 130 can be disposed inside the chamber 104 and a second portion of the motor 130 can be disposed outside of the chamber 104. Various embodiments of motors are described, for example, in previously mentioned Intl. Pat. App. No. PCT/CN2022/092688 entitled “Agitator For A Carbonation System” filed May 13, 2022.

FIG. 2 illustrates another embodiment of a carbonation system 200 configured to form a carbonated fluid. The carbonation system 200 of this illustrated embodiment includes an agitator (labelled “impeller” in FIG. 2) 202 and includes a mixing chamber 204 in which the agitator 202 is disposed and configured to rotate to form a carbonated fluid. The carbonation system 200 of FIG. 2 is generally configured and used similar to the carbonation system 100 of FIG. 1, e.g., includes a liquid source 206, a flow meter 208, a pump 210, a gas source 212, a gas regulator 214 configured to regulate an amount of gas that flows from the gas source 212 to the chamber 204, a gas solenoid valve 216, an outlet valve 224, a first air pump 218 configured to drive a flow of carbonated fluid out of the chamber through the outlet valve 224, a vent solenoid valve 220, a PRV 222, and a motor 230. The liquid is water in this illustrated embodiment such that the liquid source 206 is a water reservoir, but another liquid can be used, such as juice.

The gas is CO₂ in this illustrated embodiment such that the gas source 212 is a CO₂ source in the form of a CO₂ cylinder, but another gas can be used. The gas regulator 214 is an 0.65 MPa gas regulator in this illustrated embodiment but other gas regulators can be used (e.g., as described above). The container into which the carbonated fluid is dispensed via the outlet valve 224 is a cup in this illustrated embodiment, but another type of container can be used. As discussed herein, the carbonation system 200 can be configured to determine an amount of gas in the gas source 212 and to trigger an alert to be provided to a user indicating that the amount of gas in the gas source 212 has reached a predetermined threshold level. As also discussed herein, the carbonation system 200 can be configured to selectively open the gas source 212 to supply gas to the mixing chamber 204 on demand for a beverage formation and dispensing process.

The carbonation system 200 also includes a first check valve 226 disposed between the high pressure pump 210 and the chamber 204. The first check valve 226 is configured to allow the liquid to flow only in a direction toward the chamber 204.

The carbonation system 200 also includes a second check valve 228 disposed between the first air pump 218 and the chamber 204. The second check valve 228 is configured to allow the air to flow only in a direction toward the chamber 204.

The carbonation system 200 also includes a back pressure PRV 232 in series with the vent solenoid valve 220 that is configured to regulate headspace pressure in the chamber 204 at a chosen value even if the vent solenoid valve 220 remains open. In this way, the timing of closing the vent solenoid valve 220 may not be critical to the correct operation of the system for dispensing. That is, the back pressure PRV 232 is configured to restrict a rate of gas escape from the chamber 204 and thereby avoid a very high rate of depressurization that can cause agitation as residual bubbles expand in fluid in the chamber 204. The back pressure PRV 232 is also configured to limit the chamber 204 pressure even if the air pump 218 is unregulated, which may allow for a lower cost air pump 218 or the use of a separate pump control loop via a pressure sensor. In this way, the back pressure PRV 232 may allow a lower system cost to be achieved with the system being configured to effectively control dispensing.

The carbonation system 200 also includes a second air pump 234, a first consumable 236, a third air pump 238, a second consumable 240. Each of the first and second consumables 236, 240 can include one or more additives including any of a variety of ingredients, including, for example, flavorants, colorants, vitamins, minerals, chemicals, other ingredients, or any suitable combination of the foregoing. The second air pump 234 is configured to cause a first additive(s) contained in the first consumable 236, e.g., a cup, a pouch, etc., to be dispensed into the cup (or other container). The third air pump 238 is configured to cause a second additive(s) contained in the second consumable 240, e.g., a cup, a pouch, etc., to be dispensed into the cup (or other container). The carbonation system 200 can be configured to allow a user to select which one or both of the first and second additives is dispensed into the cup (or other container) and/or to allow the user to select an amount of the selected additive(s) to be dispensed into the cup (or other container). The user may select no additive. The selected additive(s) can be dispensed into the cup (or other container) before the carbonated fluid is dispensed, after the carbonated fluid is dispensed, or simultaneously with the dispensing of the carbonated fluid. Various embodiments of carbonation systems configured to add additive(s) are described, for example, in U.S. patent application Ser. No. 17/744,459 entitled “Flavored Beverage Carbonation System” filed May 13, 2022 and U.S. patent application Ser. No. 17/989,640 entitled “Ingredient Containers For Use With Beverage Dispensers” filed Nov. 17, 2022, which are hereby incorporated by reference in their entireties.

The carbonation system 200 in the illustrated embodiment of FIG. 2 is configured to add one or more additives, but in other embodiments the carbonation system 200 can be configured to not add any additives. FIGS. 5A-7B illustrate other examples of a carbonation system 500, 600, 700 configured to add an additive. FIGS. 1, 3, and 4 illustrate examples of carbonation systems 100, 300, 400 that do not add any additives, although such systems could be configured to add an additive.

The carbonation systems 100, 200 of FIGS. 1 and 2 (and the carbonation system 400 of FIG. 4 discussed below) each include an air pump 118, 218 configured to introduce air into their respective chambers 104, 204 to drive a flow of the carbonated fluid to dispense carbonated fluid through the outlet valve 128, 224. Using air in dispensing carbonated fluid re-enriches the chamber 104, 204 with air at every mixing cycle, which then affects the next mixing cycle. In the next mixing cycle, the chamber 104, 204 is mostly filled with air during its filling with the liquid, so the carbon dioxide gas cannot start to dissolve in the chamber 104, 204 during the filling cycle, but only in the next stage of the process when the gas regulator 114, 214 supplies gas, e.g., high pressure gas, into the chamber 104, 204. Air pumps 118, 218 are generally low cost, but a flow rate provided by the air pump 118, 218 must be equal than or greater to a dispense flow rate, e.g., greater than or equal to 2 L/min, to effectively dispense the carbonated fluid. In some embodiments, the air in a chamber may be vented during the filling of the liquid, for example, using the vent solenoid valve 120, 220.

In other embodiments, rather than using air (including its constituent gasses), a carbonation system can be configured to introduce a gas other than air from a gas source into a chamber to dispense carbonated fluid through an outlet valve. In such embodiments, a pressure within the chamber is configured to drive a flow of the treated fluid out of the chamber through the outlet valve before the gas source, e.g., the gas source 112 of FIG. 1, the gas source 212 of FIG. 2, a gas source 412 of FIG. 4, etc., is actuated to introduce gas into the chamber with a gas regulator, e.g., the gas regulator 114 of FIG. 1, the gas regulator 214 of FIG. 2, a gas regulator 414 of FIG. 4, etc., that control an injection rate of the gas into the chamber. In an illustrative embodiment, the gas source from which gas is introduced into the chamber for purposes of dispensing the carbonated fluid is the same gas source that supplies gas to the chamber for treating (e.g., mixing with) a liquid in the chamber, for example a CO₂ canister. Agitation may last for a shorter amount of time when using the treatment gas for dispensing instead of air since any treatment gas remaining in the chamber from a last carbonation-dispense cycle can start to dissolve in the chamber as soon as liquid starts to be introduced into the chamber, instead of waiting until filling with water is complete and/or agitation has started. For example, sufficient agitation may last 12 seconds when air is used for dispensing but last only 10 seconds when a gas from another gas source is used for dispensing. Also, the effective concentration of gas in the chamber's headspace may be increased in the absence of dilution by residual air introduced into the chamber during an earlier cycle to aid in dispensing.

The valve used in introducing the gas into the chamber for purposes of mixing can be the same valve used in introducing the gas into the chamber for purposes of dispensing, or different valves may be used. If the same valve is used, the valve can be a proportional valve that has a range of flow settings or a digital valve that opens in pulses to accommodate different gas introductions for mixing and for dispensing. Using different valves can allow for a valve to be used in introducing the gas into the chamber for purposes of dispensing that is adapted for use with much lower target pressures than used in introducing gas for purposes of mixing since less gas is typically introduced for dispensing than for mixing, in which a larger amount of gas is typically introduced into the chamber very quickly.

FIG. 3 illustrates one embodiment of a carbonation system 300 configured to form a carbonated fluid and configured to use gas in dispensing the carbonated fluid. The carbonation system 300 includes an agitator (labelled “impeller” in FIG. 3) 302 and includes a mixing chamber 304 in which the agitator 302 is disposed and configured to rotate to form a carbonated fluid. The carbonation system 300 of FIG. 3 is generally configured and used similar to the carbonation systems 100, 200 of FIGS. 1 and 2 except for the dispensing using gas, e.g., includes a liquid source 306, a flow meter 308, a pump 310 (e.g., a high pressure pump), a gas source 312, a gas regulator 314 configured to regulate an amount of gas that flows from the gas source 312 to the chamber 304, a first gas solenoid valve 316, an air pump 318, a first check valve 320, a vent solenoid valve 322, a PRV 324, a pressure sensor 326, a temperature sensor 328, a back pressure PRV 330, an outlet valve 332, a motor 334, and a second check valve 336. The liquid is water in this illustrated embodiment such that the liquid source 306 is a water reservoir, but another liquid can be used, such as juice. The temperature sensor 328 is an NTC thermistor in this illustrated embodiment, but another type of temperature sensor can be used, or a temperature sensor may be omitted. The air pump 318 and the first check valve 320 may be omitted in embodiments in which gas from a non-air source (e.g., from a CO₂ canister) is used to aid in dispensing the carbonated fluid.

The gas is CO₂ in this illustrated embodiment such that the gas source 312 is a CO₂ cylinder in this illustrated embodiment but another gas can be used. The gas regulator 314 is an 0.8 MPa gas regulator in this illustrated embodiment but other gas regulators can be used (e.g., as described elsewhere herein). As discussed herein, the carbonation system 300 can be configured to determine an amount of gas in the gas source 312 and to trigger an alert to be provided to a user indicating that the amount of gas in the gas source 312 has reached a predetermined threshold level. As also discussed herein, the carbonation system 300 can be configured to selectively open the gas source 312 to supply gas to the mixing chamber 304 on demand for a beverage formation and dispensing process.

The carbonation system 300 also includes a second gas solenoid valve 338 and a flow control needle valve 340 that are configured to allow gas to flow from the gas source 312 into the chamber 304 to cause carbonated fluid to exit the chamber 304 for dispensing through the outlet valve 332. A pressure within the chamber 304 is configured to drive a flow of the carbonated fluid out of the chamber 304 through the outlet valve 332 before the gas source 312 is actuated to introduce gas into the chamber 304. Various embodiments of such flow control are described, for example, in previously mentioned U.S. patent application Ser. No. 17/821,212 entitled “Beverage Carbonation System Flow Control” filed Aug. 22, 2022.

FIG. 4 illustrates another embodiment of a carbonation system 400 configured to form a carbonated fluid. The carbonation system 400 of this illustrated embodiment includes an agitator (labelled “impeller” in FIG. 4) 402 and includes a mixing chamber 404 in which the agitator 402 is disposed and configured to rotate to form a carbonated fluid. The carbonation system 400 of FIG. 4 is generally configured and used similar to the carbonation systems 100, 200, 300 of FIGS. 1-3, e.g., includes a liquid source 406, a pump 410, a gas source 412, a gas regulator 414 configured to regulate an amount of gas that flows from the gas source 412 to the chamber 404, a gas solenoid valve 416, an outlet valve 424, a first air pump 418 configured to drive a flow of carbonated fluid out of the chamber through the outlet valve 424, and a motor 430. The liquid is water in this illustrated embodiment such that the liquid source 406 is a water reservoir, but another liquid can be used, such as juice. The container into which the carbonated fluid is dispensed via the outlet valve 424 is a cup in this illustrated embodiment, but another type of container can be used.

The gas is CO₂ in this illustrated embodiment such that the gas source 412 is a CO₂ source in the form of a CO₂ cylinder, but another gas can be used. The gas regulator 414 is an 0.65 MPa gas regulator in this illustrated embodiment but other gas regulators can be used (e.g., as described above). As discussed herein, the carbonation system 400 can be configured to determine an amount of gas in the gas source 412 and to trigger an alert to be provided to a user indicating that the amount of gas in the gas source 412 has reached a predetermined threshold level. As also discussed herein, the carbonation system 400 can be configured to selectively open the gas source 412 to supply gas to the mixing chamber 404 on demand for a beverage formation and dispensing process.

The motor 430 in this illustrated embodiment is located on a bottom side of the chamber 404 but can be located elsewhere, such as on a top side of the chamber 404. In the embodiments of FIGS. 1-3, the motor 130, 230, 330 is located on a top side of the chamber 104, 204, 304 but can be located elsewhere, such as on a bottom side of the chamber 104, 204, 304.

The carbonation system 400 also includes a first check valve 426 disposed between the high pressure pump 410 and the chamber 404. The first check valve 426 is configured to allow the liquid to flow only in a direction toward the chamber 404.

The carbonation system 400 also includes a second check valve 428 disposed between the first air pump 418 and the chamber 404. The second check valve 428 is configured to allow the air to flow only in a direction toward the chamber 404.

The carbonation system 400 also includes a third check valve 432 disposed between the gas solenoid 416 and the chamber 404. The third check valve 432 is configured to allow the gas (e.g., the CO₂) to flow only in a direction toward the chamber 404.

The carbonation system 400 can include a flow meter (not shown) as discussed herein, a pressure sensor (not shown) as discussed herein, and/or a temperature sensor (not shown) as discussed herein.

The carbonation system 400 also includes a venting system configured to vent the chamber 404. The venting system includes a first vent solenoid valve 434, a second vent solenoid valve 420, a vent restrictor (also referred to herein as a “flow restrictor”) 436, and a PRV 422. When venting pressure from the mixing chamber 404, a sharp pressure drop can cause carbonation loss in the carbonated fluid, thereby reducing the carbonation level from its desired level. As discussed further herein, the venting system is configured to reduce an extent of such pressure drops and thereby improve carbonation retention in the carbonated fluid.

FIGS. 5A and 5B illustrate another embodiment of a carbonation system 500 configured to form a carbonated fluid. A cover 502 of the carbonation system 500 is omitted in FIG. 5A to show a mixing chamber 504 of the carbonation system 500. Various embodiments of mixing chambers are described, for example, in previously mentioned Intl. Pat. App. No. PCT/CN2022/092688 entitled “Agitator For A Carbonation System” filed May 13, 2022. The carbonation system 500 can have a variety of configurations, such as a configuration similar to the carbonation system 100 of FIG. 1, the carbonation system 200 of FIG. 2, the carbonation system 300 of FIG. 3, the carbonation system 400 of FIG. 4, a carbonation system 600 of FIGS. 6A and 6B, a carbonation system 700 of FIGS. 7A-7C, or other carbonation system described herein.

The carbonation system 500 includes a liquid reservoir 506 in the form of a pitcher configured to be releasably coupled to a housing 508 of the carbonation system 500 in which the chamber 504 is located. Other liquid reservoirs can be used, and the pitcher 506 can have any of a variety of configurations. A check valve, such as the first check valve 226 of FIG. 2, the second check valve 336 of FIG. 3, or the first check valve 426 of FIG. 4, can be configured to automatically open in response to the pitcher 506 being seated in a base or dock (not shown) of the carbonation system 500 to allow liquid, e.g., water, in the pitcher 506 to flow out of the pitcher 506 and into the chamber 504. In some embodiments, the liquid reservoir can be integral to the carbonation system 500, such as by being a built-in refillable tank or other refillable reservoir, instead of being configured to releasably couple to the carbonation system 500. Various embodiments of carbonation systems configured to be in selective fluid communication with a liquid source are described, for example, in previously mentioned U.S. patent application Ser. No. 17/744,459 entitled “Flavored Beverage Carbonation System” filed May 13, 2022 and U.S. patent application Ser. No. 17/989,640 entitled “Ingredient Containers For Use With Beverage Dispensers” filed Nov. 17, 2022.

The chamber 504 is configured to receive liquid therein through a liquid inlet (obscured in the figures) operably coupled to the liquid source 506 (e.g., through liquid tubing and/or other components) and is configured to receive gas therein through a gas inlet (obscured in the figures) operably coupled to a gas source (obscured in the figures) of the carbonation system 500 (e.g., through gas tubing and/or other components). Excess gas not dispensed from the chamber 504 through an outlet valve is configured to exit the chamber 504 through an outlet (obscured in the figures) operably coupled to a vent solenoid (obscured in the figures), such as the vent solenoid 120 of FIG. 1, the vent solenoid 220 of FIG. 2, the vent solenoid 322 of FIG. 3, the vent solenoids 420, 434 of FIG. 4, etc.

As discussed herein, the carbonation system 500 can be configured to determine an amount of gas in the gas source and to trigger an alert to be provided to a user indicating that the amount of gas in the gas source has reached a predetermined threshold level. As also discussed herein, the carbonation system 500 can be configured to selectively open the gas source to supply gas to the mixing chamber 504 on demand for a beverage formation and dispensing process.

The carbonation system 500 in this illustrated embodiment is configured to selectively dispense first and second additives from first and second consumables 510, 512, respectively, into a container placed on a container base 514 of the carbonation system 500 that can also serve as a drip tray. However, as discussed above, the carbonation system 500 can be configured to add no additive or to add a different number of additives. As discussed herein, the venting of the mixing chamber 504 can vent to the drip tray 514 for collection of excess moisture.

The carbonation system 500 also includes a processor (obscured in FIGS. 5A and 5B), such as a microcontroller that includes a processor and a memory, or other type of processor, disposed in the housing 508. In general, the processor is configured to execute instructions stored in a memory (obscured in FIGS. 5A and 5B) disposed in the housing 508 to cause various actions to occur, such as opening of an outlet valve of the carbonation system 500, causing the first additive(s) to be dispensed from the first additives) consumable 510, causing the second additive(s) to be dispensed from the second consumable 512, causing an alert (e.g., an illuminated (solid or blinking) light, an emitted sound, etc.) to be provided to a user when the carbonated fluid has finished being dispensed from the carbonation system 500, causing an alert (e.g., an illuminated light, an emitted sound, etc.) to be provided to a user when an amount of CO₂ in the carbonation system's gas source is determined to be at or below a threshold amount of CO₂, causing an alert (e.g., an illuminated light, an emitted sound, etc.) to be provided to a user when a temperature of the liquid in the liquid source is below a threshold minimum temperature and/or is above a threshold maximum temperature, etc. Other embodiments of treatment systems (e.g., the carbonation system 100 of FIG. 1, the carbonation system 200 of FIG. 2, the carbonation system 300 of FIG. 3, the carbonation system 400 of FIG. 4, a carbonation system 600 of FIGS. 6A and 6B, a carbonation system 700 of FIGS. 7A-7C, etc.) described herein similarly include a processor.

FIGS. 6A and 6B illustrate another embodiment of a carbonation system 600 configured to form a carbonated fluid. A portion of a housing 608 of the carbonation system 600 is omitted in FIG. 6B to show an interior of the carbonation system 600. The carbonation system 600 can have a variety of configurations, such as a configuration similar to the carbonation system 100 of FIG. 1, the carbonation system 200 of FIG. 2, the carbonation system 300 of FIG. 3, the carbonation system 400 of FIG. 4, the carbonation system 500 of FIGS. 5A and 5B, a carbonation system 700 of FIGS. 7A-7C, or other carbonation system described herein.

The carbonation system 600 includes a liquid source 606 in the form of a pitcher configured to be releasably coupled to the carbonation system 600 that includes a mixing chamber 604 in which the liquid can be mixed with a gas. Other liquid sources can be used, and the pitcher 606 can have any of a variety of configurations. A check valve, such as the first check valve 226 of FIG. 2, the second check valve 336 of FIG. 3, or the first check valve 426 of FIG. 4, can be configured to automatically open in response to the pitcher 606 being seated in a base 616 of the carbonation system 600 to allow liquid, e.g., water, in the pitcher 606 to flow out of the pitcher 606 and into the mixing chamber. In some embodiments, the liquid reservoir can be integral to the carbonation system 600, such as by being a built-in refillable tank or other refillable reservoir, instead of being configured to releasably couple to the carbonation system 600. Various embodiments of carbonation systems configured to be in selective fluid communication with a liquid source are described, for example, in previously mentioned U.S. patent application Ser. No. 17/744,459 entitled “Flavored Beverage Carbonation System” filed May 13, 2022 and U.S. patent application Ser. No. 17/989,640 entitled “Ingredient Containers For Use With Beverage Dispensers” filed Nov. 17, 2022.

The carbonation system 600 includes a gas source 612 in the form of a CO₂ canister 612 configured to be removably coupled to the carbonation system 600 that includes the mixing chamber 604. Other gas sources can be used, and the CO₂ canister 612 can have any of a variety of configurations. As discussed herein, the carbonation system 600 can be configured to determine an amount of gas in the gas source 612 and to trigger an alert to be provided to a user (e.g., via a user interface 622) indicating that the amount of gas in the gas source 612 has reached a predetermined threshold level. As also discussed herein, the carbonation system 600 can be configured to selectively open the gas source 612 to supply gas to the mixing chamber 604 on demand for a beverage formation and dispensing process.

The carbonation system 600 in this illustrated embodiment is configured to selectively dispense first and second additives from first and second consumables 610a, 610b, respectively, into a container 618 (shown as a cup in this illustrated embodiment) placed on a container base 614 of the carbonation system 600 that can also serve as a drip tray. The carbonation system 600 includes a carriage assembly 620 configured to receive the first and second consumables 610a, 610b. However, as discussed above, the carbonation system 600 can be configured to add no additive or to add a different number of additives. As discussed herein, the venting of the mixing chamber 604 can vent to the drip tray 614 for collection of excess moisture.

The carbonation system 600 includes a user interface 622 configured to receive input from a user regarding one or more aspects of the carbonation system 600 (e.g., volume of carbonated fluid to be dispensed, carbonation level, specific additives, additive amount, etc.) and/or configured to provide alerts (e.g., audible and/or visual) as described herein to the user regarding one or more aspects of the carbonation system 600 (e.g., an amount of gas in the gas source 612, status of whether the carbonated fluid has finished being dispensed from the carbonation system 600, a temperature of the liquid in the liquid source 606, power on/off status of the carbonation system 600, etc.).

The mixing chamber 604 is configured to receive liquid therein through a liquid inlet (obscured in the figures) operably coupled to the liquid source 606 (e.g., through liquid tubing and/or other components) and is configured to receive gas therein through a gas inlet (obscured in the figures) operably coupled to the gas source 612 (e.g., through gas tubing and/or other components). Excess gas not dispensed from the chamber 604 through an outlet valve is configured to exit the chamber 604 through an outlet (obscured in the figures) operably coupled to a vent solenoid (obscured in the figures), such as the vent solenoid 120 of FIG. 1, the vent solenoid 220 of FIG. 2, the vent solenoid 322 of FIG. 3, the vent solenoids 420, 434 of FIG. 4, etc.

FIGS. 7A-7C illustrate another embodiment of a carbonation system 700 configured to form a carbonated fluid. The carbonation system 700 can have a variety of configurations, such as a configuration similar to the carbonation system 100 of FIG. 1, the carbonation system 200 of FIG. 2, the carbonation system 300 of FIG. 3, the carbonation system 400 of FIG. 4, the carbonation system 500 of FIGS. 5A and 5B, the carbonation system 600 of FIGS. 6A and 6B, or other carbonation system described herein.

The carbonation system 700 includes a liquid source 706 in the form of a bottle configured to be releasably coupled to the carbonation system 700 that includes a mixing chamber (obscured in the figures) in which the liquid can be mixed with a gas. Other liquid sources can be used, and the bottle 706 can have any of a variety of configurations. A check valve, such as the first check valve 226 of FIG. 2, the second check valve 336 of FIG. 3, or the first check valve 426 of FIG. 4, can be configured to automatically open in response to the liquid source 706 being seated in a base 716 of the carbonation system 700 to allow liquid, e.g., water, in the pitcher 706 to flow out of the liquid source 706 and into the mixing chamber. FIG. 7A shows the liquid source 706 removably coupled to the carbonation system 700 via the base 716. FIGS. 7B and 7C show the liquid source 706 as a standalone element not coupled to the carbonation system 700. In some embodiments, the liquid reservoir can be integral to the carbonation system 700, such as by being a built-in refillable tank or other refillable reservoir, instead of being configured to releasably couple to the carbonation system 700. Various embodiments of carbonation systems configured to be in selective fluid communication with a liquid source are described, for example, in previously mentioned U.S. patent application Ser. No. 17/744,459 entitled “Flavored Beverage Carbonation System” filed May 13, 2022 and U.S. patent application Ser. No. 17/989,640 entitled “Ingredient Containers For Use With Beverage Dispensers” filed Nov. 17, 2022.

The carbonation system 700 includes a gas source 712 configured to be removably coupled to the carbonation system 700 that includes the mixing chamber. The gas source 712 in this illustrated embodiment is in the form of a CO₂ canister. A gas source chamber cover 724 that forms part of and is releasably coupled to a housing 708 of the carbonation system 700 is released from the housing 708 in FIGS. 7B and 7C to show a gas source chamber 726 of the carbonation system 700 that is configured to removably receive the gas source 712 therein. The gas source chamber cover 724 in this illustrated embodiment is shown as being completely releasable from the housing 708, but in other embodiments can be partially releasable so as to open and provide access to the gas source chamber 726, e.g., by being a hinged door, by being slidable into a portion of the housing 702, etc. FIG. 7B shows the gas source 712 located in the gas source chamber 726 and removably coupled to the carbonation system 700. FIGS. 7C and 7D show the gas source 712 as a standalone element located outside of the gas source chamber 726 and not coupled to the carbonation system 700. Other gas sources can be used. As discussed herein, the carbonation system 700 can be configured to determine an amount of gas in the gas source 712 and to trigger an alert to be provided to a user (e.g., via a user interface 722) indicating that the amount of gas in the gas source 712 has reached a predetermined threshold level. As also discussed herein, the carbonation system 700 can be configured to selectively open the gas source 712 to supply gas to the mixing chamber on demand for a beverage formation and dispensing process.

As shown in FIG. 7D, the gas source 712 includes a pin 712p, e.g., a valve pin, at an upper end of the gas source 712. The pin 712p is configured to move between an extended position, in which the gas source 712 is closed such that gas cannot be released therefrom, and a compressed position, in which the pin 712p has moved to open a valve such that the gas source 712 is open such that gas can be released therefrom. With the gas source 712 open, gas is configured to be released therefrom to a gas regulator 718 (see FIGS. 7F and 7G) of the carbonation system 700.

The carbonation system 700 in this illustrated embodiment is configured to selectively dispense first and second additives from first and second consumables 710a, 710b, respectively, into a container (not shown) placed on a container base 714 of the carbonation system 700 that can also serve as a drip tray. The carbonation system 700 includes a carriage assembly 720 configured to receive the first and second consumables 710a, 710b. However, as discussed above, the carbonation system 700 can be configured to add no additive or to add a different number of additives. As discussed herein, the venting of the mixing chamber can vent to the drip tray 714 for collection of excess moisture.

The carbonation system 700 includes a user interface 722 configured to receive input from a user regarding one or more aspects of the carbonation system 700 (e.g., volume of carbonated fluid to be dispensed, carbonation level, specific additives, additive amount, etc.) and/or configured to provide alerts (e.g., audible and/or visual) as described herein to the user regarding one or more aspects of the carbonation system 700 (e.g., an amount of gas in the gas source 712, status of whether the carbonated fluid has finished being dispensed from the carbonation system 700, a temperature of the liquid in the liquid source 706, power on/off status of the carbonation system 700, etc.).

The mixing chamber of the carbonation system 700 is configured to receive liquid therein through a liquid inlet (obscured in the figures) operably coupled to the liquid source 706 (e.g., through liquid tubing and/or other components) and is configured to receive gas therein through a gas inlet (obscured in the figures) operably coupled to the gas source 712 (e.g., through gas tubing and/or other components). Excess gas not dispensed from the mixing chamber through an outlet valve is configured to exit the chamber 704 through an outlet (obscured in the figures) operably coupled to a vent solenoid (obscured in the figures), such as the vent solenoid 120 of FIG. 1, the vent solenoid 220 of FIG. 2, the vent solenoid 322 of FIG. 3, the vent solenoids 420, 434 of FIG. 4, etc.

As shown in FIG. 7N, the carbonation system 700 also includes a printed circuit board (PCB) 748 disposed in the housing 702 and including various components, such as a processor (e.g., a microcontroller that includes a processor and a memory, or other type of processor) and a memory, configured to facilitate operation of the carbonation system 700. The PCB 748 can have a variety of configurations and, in some embodiments, the processor can be included in the carbonation system 700 without use of a PCB. In general, the processor is configured to execute instructions stored in the memory to cause various actions to occur, such as opening of an outlet valve of the carbonation system 700 to dispense carbonated fluid, causing the first additive(s) to be dispensed from the first additives) consumable 710a, causing the second additive(s) to be dispensed from the second consumable 710b, causing an alert (e.g., an illuminated (solid or blinking) light, an emitted sound, etc.) to be provided to a user when the carbonated fluid has finished being dispensed from the carbonation system 700, etc. Other embodiments of treatment systems described herein similarly include a processor.

Selectively Activating Gas Release from a Gas Source

In some embodiments, methods, systems, and devices for selectively releasing CO₂ from a gas source in a beverage carbonation system are provided. As mentioned above, the methods, systems, and devices can be implemented in treatment systems similar to the carbonation systems described herein except instead of mixing CO₂ with a liquid, a different gas is mixed with the liquid.

In general, a carbonation system (e.g., the carbonation system 100 of FIG. 1, the carbonation system 200 of FIG. 2, the carbonation system 300 of FIG. 3, the carbonation system 400 of FIG. 4, the carbonation system 500 of FIGS. 5A and 5B, the carbonation system 600 of FIGS. 6A and 6B, the carbonation system 700 of FIGS. 7A-7C, etc.) can be configured to selectively activate release of gas from a gas source of the carbonation system. As discussed herein, for each carbonated fluid to be formed in a mixing chamber of the carbonation system, only a certain amount of CO₂ is supplied from the gas source to the mixing chamber. Further, the CO₂ is configured to be supplied to the mixing chamber on demand in response to a user input to the carbonation system, e.g., via a user interface thereof, to form and dispense a beverage. Thus, the gas source only needs to be open at certain times to release CO₂ therefrom, e.g., times when CO₂ is being supplied to the mixing chamber to form a carbonated fluid. However, the CO₂ contained in the gas source (e.g., the CO₂ canister 112 of FIG. 1, the CO₂ canister 212 of FIG. 2, the CO₂ canister 312 of FIG. 3, the CO₂ canister 412 of FIG. 4, the CO₂ canister 612 of FIG. 6B, the CO₂ canister 712 of FIGS. 7B-7D, etc.) can be at a high pressure. Selectively activating release of CO₂ from the gas source can allow the gas source to be closed when CO₂ release is not needed and to be open when CO₂ release is needed. A risk of high pressure from the CO₂ canister being introduced unintentionally into the carbonation system can therefore be reduced, thereby helping to prevent unintentional high-pressure release that may severely damage the system.

Automating the actuation and de-actuation of a gas source (e.g., the CO₂ canister 112 of FIG. 1, the CO₂ canister 212 of FIG. 2, the CO₂ canister 312 of FIG. 3, the CO₂ canister 412 of FIG. 4, the CO₂ canister 612 of FIG. 6B, the CO₂ canister 712 of FIGS. 7B-7D, etc.) in a treatment system (e.g., the carbonation system 100 of FIG. 1, the carbonation system 200 of FIG. 2, the carbonation system 300 of FIG. 3, the carbonation system 400 of FIG. 4, the carbonation system 500 of FIGS. 5A and 5B, the carbonation system 600 of FIGS. 6A and 6B, the carbonation system 700 of FIGS. 7A-7C, etc.) according to the methods, systems, and devices described herein for selectively releasing gas from the gas source may prevent pressure from building up between the gas source and a gas regulator (e.g., the gas regulator 114 of FIG. 1, the gas regulator 214 of FIG. 2, the gas regulator 314 of FIG. 3, the gas regulator 414 of FIG. 4, a gas regulator 718 of FIG. 7G, etc.), and/or between the gas source and a mixing chamber (e.g., the mixing chamber 104 of FIG. 1, the mixing chamber 204 of FIG. 2, the mixing chamber 304 of FIG. 3, the mixing chamber 404 of FIG. 4, the mixing chamber 504 of FIG. 5A, the mixing chamber 604 of FIG. 6B, etc.), when a fluid is not being treated, e.g., when the treatment system is not in use. Preventing pressure from building up may prevent damage to the treatment system.

In some embodiments, a motor of a carbonation system is configured to drive a cam in a first drive motion that moves the cam to push on a pin of a gas source coupled to the carbonation system. The pin is biased upward due to the pressurized contents of the gas source. The cam pushing on the gas source's pin causes the gas source to open, e.g., by pushing on a valve, and thereby release gas to a gas regulator of the carbonation system so the gas can be supplied to the carbonation system's mixing chamber. The motor is configured to drive the cam in a second drive motion that moves the cam back to its initial position, which removes force on the pin so that the biased pin can return to its initial position. The gas source thus closes such that gas cannot be released from the gas source until the cam moves again, e.g., in a subsequent carbonated fluid formation process.

In some embodiments, the carbonation system is configured to automatically open the gas source of the carbonation system in response to a start of a carbonated fluid formation process. The start of the carbonated fluid formation process can be manually triggered by a user, such as by the user providing an input to a user interface of the carbonation system that starts beverage formation. A processor of the carbonation system is configured to receive a signal indicative of the start of the carbonation process, e.g., receive a signal from the user interface, receive a signal from external device communicatively coupled with the carbonation system, etc. The processor's receipt of the signal triggers the processor to transmit a first control signal to the motor that causes the motor of the carbonation system to drive the cam in the first drive motion. Thereafter, the processor is configured to transmit a second control signal to the motor that causes the motor to drive the cam in the second drive motion. A length of time between the first and second control signals is defined by an amount of gas to be supplied from the gas source to the mixing chamber, e.g., based on one or more parameters such as a user's selection of carbonation level, a user's selection of volume, and a temperature of the liquid to be mixed with the gas. The gas source is thus open only for an amount of time needed to release the proper amount of gas therefrom for a particular carbonated fluid's formation.

One embodiment of a carbonation system configured to selectively activate release of gas from a gas source of the carbonation system is described below with respect to the carbonation system 700 of FIGS. 7A-7C, but other carbonation systems can be similarly configured to selectively activate release of gas from a gas source.

As shown in FIGS. 7E-7I, the carbonation system 700 includes a motor 728 and a drive member 730 (also referred to herein as an “axle” or “drive axle”) operably coupled to the motor 728 and configured to be driven by the motor 728. The drive member 730 is also operably coupled to the gas source 712, as shown in FIGS. 7F-7H. As discussed further below, the motor 728 is configured to drive the drive member 730 to move relative to the gas source 712, thereby causing the gas source 712 to open or close. Whether the gas source 712 opens or closes depends on a direction of rotation of the drive member 730 relative to the gas source 712. Thus, the motor 728 driving the drive member 730 to rotate in a first direction D1 (see FIG. 7H) relative to the gas source 712 is configured to cause the gas source 712 to open, and the motor 728 driving the drive member 730 to rotate in a second, opposite direction D2 relative to the gas source 712 is configured to cause the gas source 712 to close. The gas source 712 can thus be selectively opened or closed.

The motor 728 can have a variety of configurations. As in this illustrated embodiment, the motor 728 can include a rotary motor configured to rotate to drive an element, e.g., to drive the drive member 730. The motor 728 is configured to rotate in one direction to cause the drive member 730 to rotate in the first direction D1 (see FIG. 7L) and thereby cause the gas source 712 to open. The motor 728 is configured to rotate in another, opposite direction to cause the drive member 730 to rotate in the second direction D2 (see FIG. 7L) and thereby cause the gas source 712 to close.

The motor 728 is operably coupled to the processor of the carbonation system 700. The processor is configured to transmit control signals to the motor 728 that control activation of the motor 728 and that therefore control opening and closing of the gas source 712.

The motor 728 is operably coupled to the drive member 730 via a gear train. As shown in FIGS. 7F, 7I, and 7J, the gear train includes a driving gear 732 and a driven gear 734. The driven gear 734 is shown as a standalone element in FIG. 7M. The driving gear 732 and a driven gear 734 are obscured in FIG. 7E by a gear cover 736. The driving gear 732 is operably coupled to the motor 728 and to the driven gear 734. The driven gear 734 is operably coupled to the drive member 730. The motor 728 is configured to rotate to drive rotation of the driving gear 732 via a gear box 752. The rotation of the driving gear 732 is configured to cause rotation of the driven gear 734 due to engaged teeth of the driving and driven gears 732, 734. The rotation of the driven gear 734 is configured to drive rotation of the drive member 730.

The driven gear 734 is configured to rotate between a first or home position, which is shown in FIGS. 7F, 7I, and 7J and corresponds to the gas source 712 being closed, and a second or activated position, which corresponds to the gas source 712 being open. Rotation of the driven gear 734 in a first direction D3 (see FIG. 7J) is configured to cause the drive member 730 to rotate in the first direction D1, which is a same direction as the driven gear's first direction D3 of rotation. Rotation of the driven gear 734 in a second, opposite direction D4 is configured to cause the drive member 730 to rotate in the second direction D2, which is a same direction as the driven gear's second direction D4 of rotation.

The driven gear 734 is configured to engage each of a first switch 738, e.g., a microswitch or other type of switch, and a second switch 740, e.g., a microswitch or other type of switch. The driven gear 734 is configured to engage only one of the first and second switches 738, 740 at a time. The driven gear 734 in the home position is configured to engage the first switch 738. The driven gear 734 in the activated position is configured to engage the second switch 740. The driven gear 734 is configured to not be engaged with either of the first and second switches 738, 740 during the rotation of the driven gear 734 from the home position to the activated position or from the activated position to the home position.

The first and second switches 738, 740 are each operably coupled to the carbonation system's processor. The first and second switches 738, 740 are each configured to transmit signals to the processor. The processor is configured to transmit control signals to the motor 728 in response to receipt of signals from the first and second switches 738, 740. The processor is also configured to transmit control signals to the motor 728 based on a user input to the carbonation system to cause movement of the driven gear 734 from the home position to the activated position, as discussed herein.

The driven gear 734 includes an opening 742 configured to seat the drive member 730 therein. The drive member 730 is configured to seat within the opening 742 in a press fit in this illustrated embodiment, but the drive member 730 can be seated within the opening 742 in other ways, such by being welded thereto, adhered thereto using adhesive, etc. The opening 742 has a non-circular shape, which can help ensure that the drive member 730 rotates with the driven gear 734 instead of the driven gear 734 rotating relative to the drive member 730. The non-circular shape in this illustrated embodiment is a D-shape, but other non-circular shapes can be used, e.g., triangular, square, elliptical, hexagonal, etc.

The drive member 730 can have a variety of configurations. As in this illustrated embodiment, the drive member 730 can include an elongate shaft 744. The drive member 730 is shown as a standalone element in FIGS. 7K and 7L.

A first portion 744a at one end of the elongate shaft 744 is configured to be seated in the opening 742 of the driven gear 734. The first portion 744a of the elongate shaft 744 therefore has a non-circular cross-sectional shape corresponding to the non-circular shape of the driven gear's opening 742 to facilitate the drive member 730 being mated to the driven gear 734 in a press fit. The first portion 744a in this illustrated embodiment thus has a D-shaped cross-sectional shape.

The drive member 730 is configured to engage the gas source 712 in a second portion 744b at an opposite end of the elongate shaft 744 from the first portion 744a. The elongate shaft 744 includes a cam 746 configured to slidably engage the gas source 712, e.g., the pin 712p thereof, as shown in FIGS. 7F-7G. As discussed further below, the cam 746 is configured to move relative to the gas source's pin 712p and thereby cause the pin 712p to move so as to move the gas source 712 between being open and closed.

As shown in FIGS. 7H and 7L, the cam 746 extends around a partial perimeter of the drive member 730. The second portion 744b of the elongate shaft 744 in this illustrated embodiment has a circular cross-sectional shape, so the cam 746 extends around a partial circumference of the drive member 730.

The cam 746 is defined by a cut-out formed in the drive member 730, e.g., at a terminal end of the elongate shaft 744 in the second portion 744b. The cam 746 has a tapered shape in which a first terminal end 746a of the cam 746 defined by the cut-out has a wider width than a second terminal end 746b of the cam 746 defined by the cut-out.

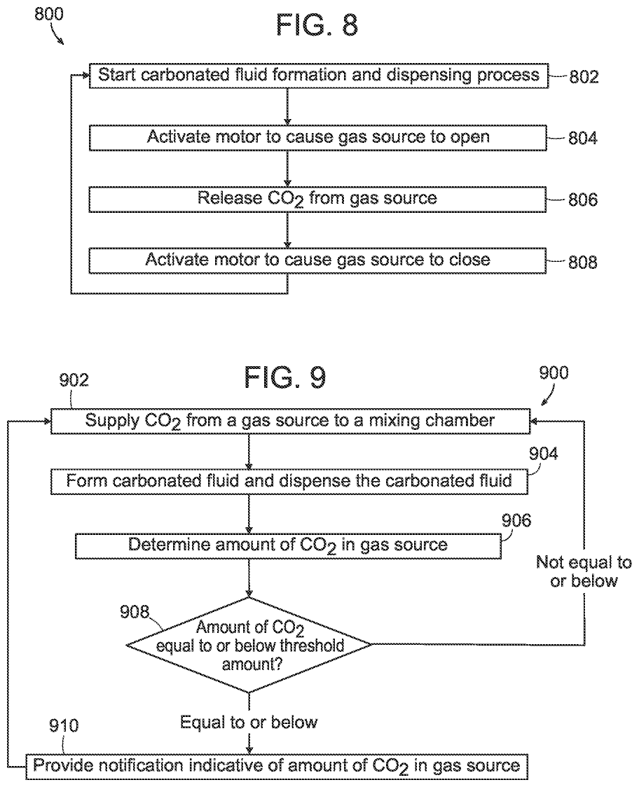

FIG. 8 illustrates one embodiment of a method 800 of selectively activating release of CO₂ from a gas source (e.g., the CO₂ canister 112 of FIG. 1, the CO₂ canister 212 of FIG. 2, the CO₂ canister 312 of FIG. 3, the CO₂ canister 412 of FIG. 4, the CO₂ canister 612 of FIG. 6B, the CO₂ canister 712 of FIG. 7B, etc.) removably coupled to a carbonation system. The method 800 is described with respect to the carbonation system 700 of FIGS. 7A-7C for ease of explanation but can be similarly performed with respect to another carbonation system (e.g., the carbonation system 100 of FIG. 1, the carbonation system 200 of FIG. 2, the carbonation system 300 of FIG. 3, the carbonation system 400 of FIG. 4, the carbonation system 500 of FIGS. 5A and 5B, the carbonation system 600 of FIGS. 6A and 6B, etc.).

The method 800 includes starting 802 a carbonated fluid formation and dispensing process. As discussed herein, the carbonated fluid formation and dispensing process can be started by a user providing an input to the carbonation system 700, such as via user interface 722 (e.g., pressing a START button, selecting an icon on a touchscreen, moving a switch similar to the light switch, etc.). In some embodiments, as shown in FIG. 7O, the carbonation system 700 is configured to be communicatively coupled with an external device 750 (e.g., a mobile phone, a tablet, a smart watch, a laptop, etc.), such as via a Bluetooth or other wireless connection, and the user can provide an input to the external device 750 which then transmits a signal to the carbonation system 700 to begin the carbonated fluid formation and dispensing process. Other embodiments of carbonation systems described herein can be configured to be communicatively coupled with an external device.

Referring again to FIG. 8, the processor of the carbonation system 700 receives a start signal indicative of the start 802 of the carbonated fluid formation and dispensing process, e.g., a signal from the user interface 722, a signal from a transceiver or other communication interface that received a signal from a user device, etc. The processor thus becomes aware that beverage formation should begin. In response to receiving the start signal, the processor activates 804 the motor 728 to cause the gas source 712 to open so gas can be supplied to the carbonation system's mixing chamber.

To activate 804 the motor 728, the processor transmits a first control signal to the motor 728 that causes the motor 728 to begin rotating in a direction that causes the drive gear 732 to rotate, and thereby cause the driven gear 734 to rotate in the first direction D3 from its home or initial position. The driven gear 734 rotating in the first direction D3 causes the drive axle 730 to rotate in the first direction D1 from its home or initial position. As the driven gear 734 moves from its home position by rotating in the first direction D3, the driven gear 734 becomes disengaged from the first switch 738. As the drive axle 730 moves from its home position by rotating in the first direction D1, the cam 746 urges the gas source's pin 712p downward as a top surface of the pin 712p slides along the drive axle 730 from the first terminal end 746a of the cam 746 toward the second terminal end 746b of the cam 746. That is, as the drive axle 730 rotates in the first direction D3, physical contact between the top surface of the pin 712p and a surface of the cam 746 moves from the first terminal end 746a to the second terminal end 746b.

When the drive axle 730 has rotated enough in the first direction D1 to be in its activated position, the cam 746 has pushed the pin 712p down enough to open the gas source 712 such that gas releases 806 from the gas source 712 to the gas regulator 718. As discussed herein, the gas regulator 718 regulates an amount of gas that flows from the gas source 712 to the carbonation system's mixing chamber. FIG. 7G illustrates flow of the gas through an outlet toward the mixing chamber.

The drive axle 730 in its activated position corresponds to the driven gear 734 having rotated enough in the first direction D3 to be in its activated position. When the driven gear 734 has rotated enough in the first direction D3 to reach its activated position, the driven gear 734 engages the second switch 740 and has fully rotated in the first direction D3. In response to the driven gear's engagement with the second switch 740, the second switch 740 transmits a signal to the processor. The processor thus becomes aware of when the gas source 712 has been opened, as the driven gear 734 in its activated position corresponds to the gas source 712 being open. The processor is aware of how much gas should be supplied from the gas source 712 to the mixing chamber to form a particular carbonated fluid. In some embodiments, a same amount of gas is supplied to the mixing chamber for each carbonated fluid to be formed. In other embodiments, as discussed herein, different amounts of gas can be supplied to the mixing chamber to form different carbonated fluids based on one or more parameters such as carbonated fluid volume, carbonation level, and liquid temperature. The processor is also aware of a gas flow rate out of the gas source 712, as gas sources have a known flow rate. Different gas sources may have different flow rates, which can be stored in a memory of the carbonation system 700. The processor can therefore be configured to calculate an amount of time that the gas source 712 should remain open to allow the proper amount of the gas to be supplied to the mixing chamber for formation of the particular beverage to be dispensed in this carbonated fluid formation and dispensing process.

Once the amount of time has passed, e.g., as determined by a counter, a timer, etc. in communication with the processor, the processor activates 808 the motor 728 to cause the gas source 712 to close. The processor transmits a second control signal to the motor 728 that causes the motor 728 to rotate in an opposite direction from which the motor 728 previously rotated to cause the gas source 712 to open. The motor 728 rotating in the opposite direction causes the drive gear 732 to rotate, thereby causing the driven gear 734 to rotate in the second direction D4. The driven gear 734 rotating in the second direction D4 from its activated position toward its home position causes the driven gear 734 to disengage from the second switch 740. The driven gear 734 rotating in the second direction D4 causes corresponding rotation of the drive member 730 in the second direction D2. As the drive member 730 rotates in the second direction D2, the pin 712p moves upward, due to being biased upward due to the pressurized contents of the gas source 712, as pressure exerted on the pin 712p by the cam 746 decreases as the top surface of the pin 712p slides along the drive member 730 from the second terminal end 746b of the cam 746 toward the first terminal end 746a of the cam 746. That is, as the drive axle 730 rotates in the second direction D4, physical contact between the top surface of the pin 712p and a surface of the cam 746 moves from the second terminal end 746b to the first terminal end 746a.

When the drive member 730 has rotated enough in the second direction D2 to be back in its home position, the pin 712p has moved back to its initial position and the gas source 712 is closed.

The drive axle 730 in its home position corresponds to the driven gear 734 having rotated enough in the second direction D4 to be back in its home position. When the driven gear 734 has rotated enough in the second direction D4 to reach its home position, the driven gear 734 engages the first switch 738 and has fully rotated in the second direction D4. In response to the driven gear's engagement with the first switch 738, the first switch 738 transmits a signal to the processor. The processor thus becomes aware of when the gas source 712 has been closed, as the driven gear 734 in the home position corresponds to the gas source 712 being closed. The gas source 712 remains closed, the axle 730 remains in its home position, and the driven gear 734 remains in its home position until the start 802 of another carbonated fluid formation and dispensing process.

### Determining Amount of Gas in a Gas Source

In some embodiments, methods, systems, and devices for determining an amount of CO₂ in a gas source in a carbonation system are provided. As mentioned above, the methods, systems, and devices can be implemented in treatment systems similar to the carbonation systems described herein except instead of mixing CO₂ with a liquid, a different gas is mixed with the liquid.

In some embodiments, a carbonation system configured to determine an amount of CO₂ in a gas source can also be configured to selectively release CO₂ from the gas source, as discussed above.

In general, a carbonation system (e.g., the carbonation system 100 of FIG. 1, the carbonation system 200 of FIG. 2, the carbonation system 300 of FIG. 3, the carbonation system 400 of FIG. 4, the carbonation system 500 of FIGS. 5A and 5B, the carbonation system 600 of FIGS. 6A and 6B, the carbonation system 700 of FIGS. 7A-7C, etc.) can be configured to determine an amount of CO₂ in a gas source, such as a CO₂ canister, removably coupled to the carbonation system. The carbonation system can also be configured to provide a notification (e.g., audible alert and/or visual alert) to a user of the carbonation system indicative of the determined CO₂ amount. The user may learn via the notification that it is time to order a new gas source to have on hand ready for use (and/or to verify that a new gas source is already readily available) because the gas source may need to be replaced soon to maintain carbonation quality of carbonated fluids formed by the carbonation system, and/or the user may learn via the notification that the gas source should now be replaced to maintain carbonation quality of carbonated fluids formed by the carbonation system.

FIG. 9 illustrates one embodiment of a method 900 of determining an amount of CO₂ in a gas source (e.g., the CO₂ canister 112 of FIG. 1, the CO₂ canister 212 of FIG. 2, the CO₂ canister 312 of FIG. 3, the CO₂ canister 412 of FIG. 4, the CO₂ canister 612 of FIG. 6B, the CO₂ canister 712 of FIG. 7B, etc.) removably coupled to a carbonation system (e.g., the carbonation system 100 of FIG. 1, the carbonation system 200 of FIG. 2, the carbonation system 300 of FIG. 3, the carbonation system 400 of FIG. 4, the carbonation system 500 of FIGS. 5A and 5B, the carbonation system 600 of FIGS. 6A and 6B, the carbonation system 700 of FIGS. 7A-7C, etc.). The method 900 includes CO₂ being supplied 902 from the gas source to a mixing chamber of the carbonation system. Although not shown in FIG. 9, liquid is also supplied to the mixing chamber from a liquid source. With liquid and gas in the mixing chamber, carbonated fluid is formed 904 in the mixing chamber by dissolving the CO₂ in the liquid, e.g., via use of an agitator in the mixing chamber agitating the CO₂ and the liquid, and then the carbonated fluid is dispensed 904 to a cup, bottle, or other container.

After the carbonated fluid has been dispensed 904, the carbonation system (e.g., a processor thereof) determines 906 an amount of CO₂ in the gas source. In other embodiments, the determination 906 can be performed after the CO₂ has been supplied 902 to the mixing chamber but before the carbonated fluid has been formed 904 and/or before the carbonated fluid has been dispensed 904. In some embodiments, the determination 906 can happen before the CO₂ has been supplied to the mixing chamber 902 (e.g., after starting 802 the carbonated fluid formation and dispensing of FIG. 8).

Determining 906 the amount of CO₂ in the gas source can include subtracting, from a current total amount of CO₂ in the gas source, an amount of CO₂ corresponding to the amount of CO₂ used to form 904 the carbonated fluid, e.g., an amount of CO₂ released from the gas source to the mixing chamber. An initial start value of the current total amount corresponds to a size of the gas source, e.g., 410 g for a 410 g CO₂ canister, 80 g for an 80 g CO₂ canister, etc. Instead of subtracting the amount of CO₂ from a current total amount of CO₂ in the gas source to determining 906 the amount of CO₂ in the gas source, a running total of amount of CO₂ in the gas source can be calculated to determine 906 the amount of CO₂ in the gas source. In such embodiments, determining 906 the amount of CO₂ in the gas source can include adding, to a current total amount of CO₂ in the gas source, an amount of CO₂ corresponding to the amount of CO₂ used to form 904 the carbonated fluid, e.g., an amount of CO₂ released from the gas source to the mixing chamber. A final end value of the current total amount corresponds to a size of the gas source, e.g., 410 g for a 410 g CO₂ canister, 80 g for an 80 g CO₂ canister, etc.

The amount of CO₂ corresponding to the amount of CO₂ used to form 904 the carbonated fluid can be a known value based on one or more parameters of the carbonated fluid formed 904. The carbonation system can be configured to store (e.g., in a memory thereof) a lookup table correlating each of the one or more parameters with CO₂ use. Such correlations can be determined experimentally. Examples of the parameters include a volume of the carbonated fluid formed 904, a carbonation level of the carbonated fluid formed 904, and a temperature of liquid used in forming 904 the carbonated fluid. Each of carbonated fluid volume, carbonated fluid carbonation level, and liquid temperature are factors that can affect how much CO₂ is supplied 902 to the mixing chamber and thus affect how much CO₂ is released from the gas source to the mixing chamber. In other embodiments, the amount of CO₂ corresponding to the amount of CO₂ used to form 904 the carbonated fluid can be a known value based on one or more parameters of the CO₂ supplied 902. One example of the one or more parameters includes a duration of the CO₂ supplied 902. In other embodiments, the amount of CO₂ corresponding to the amount of CO₂ used to form 904 the carbonated fluid can be a known value based on a combination of one or more parameters of the CO₂ supplied 902 and one or more parameters of the carbonated fluid formed 904.

The volume of the carbonated fluid formed 904 can be a predetermined volume in embodiments in which the carbonation system can only dispense one size of carbonated fluid. In other embodiments, the carbonation system is configured to allow a user to select the volume (e.g., small, medium, large; 4 oz., 6 oz., 8 oz., 16 oz., 24 oz., 32 oz.; etc.), such as via the carbonation system's user interface or via an external device (e.g., via a user interface thereof), prior to the carbonated fluid being formed 904.

The carbonation level of the carbonated fluid formed 904 can be a predetermined carbonation level in embodiments in which the carbonation system can only provide one carbonation level of carbonated fluid. In other embodiments, the carbonation system is configured to allow a user to select the carbonation level (e.g., high, medium, or low; high or low; etc.) via the carbonation system's user interface prior to the carbonated fluid being formed 904.

The carbonation system can include a temperature sensor configured to measure temperature in the carbonation system's mixing chamber, as discussed above. The sensed temperature can be considered a temperature of the liquid used in forming 904 the carbonated fluid. Alternatively, the carbonation system can include a temperature sensor (e.g., an NTC thermistor or other temperature sensor) configured to sense the liquid's temperature. The temperature sensor can be configured to be in direct contact with the liquid, such as when a check valve (e.g., the first check valve 226 of FIG. 2, the second check valve 336 of FIG. 3, or the first check valve 426 of FIG. 4, etc.) opens in response to the liquid source being seated in a base of the carbonation system configured to releasably seat the liquid source, or such as the temperature sensor being included in liquid tubing through which the liquid flows from the liquid source to the mixing chamber.

Table 1 below shows one embodiment of a lookup table correlating carbonation level (high, medium, and low in this embodiment) and volume (6 oz. and 12 oz. in this embodiment) to amounts of CO₂ released from a gas source (a 410 g 60 L CO₂ canister in this illustrated embodiment). For example, Table 1 shows that 1.54 g of CO₂ is released from the gas source for a 6 oz. beverage at a low carbonation level. Table 1 also correlates drink formation cycles to carbonation level and volume. For example, Table 1 shows that a 410 g CO₂ source can be used to form 266.2 beverages each having a 6 oz. volume and a low carbonation level.

TABLE 1

| | 6 oz. CO₂ | 12 oz. CO₂ | New | | |
|---|---|---|---|---|---|
| Car- | Consump- | Consump- | CO₂ | 6 oz. CO₂ | 12 oz. CO₂ |
| bonation | tion | tion | Source | Cycles/ | Cycles/ |
| Level | (g) | (g) | (g) | Canister | Canister |
| Low | 1.54 | 3.28 | 410 | 266.2 | 125.0 |
| Medium | 2 | 4.12 | 410 | 205.0 | 99.5 |
| High | 2.52 | 5.18 | 410 | 162.7 | 79.2 |

Using the embodiment of Table 1 by way of example, if a 6 oz. beverage at a low carbonation level is formed 904 as a first beverage in which the gas source is being used, determining 906 the amount of CO₂ in the gas source can include subtracting 1.54 from 410 such that 408.46 g is determined 906 to be the current total amount of CO₂ in the gas source. If the next beverage formed 904 is a 12 oz. beverage at a medium carbonation level, determining 906 the amount of CO₂ in the gas source can include subtracting 4.12 from 408.46 such that 404.34 g is determined 906 to be the current total amount of CO₂ in the gas source.

Table 2 below shows one embodiment of a lookup table correlating carbonation level (high, medium, and low in this embodiment) and liquid temperature (40° F., 45° F., and 50° F. in this embodiment) for a 6 oz. volume beverage. Variables x, y, z, a, b, and c in Table 2 are experimentally determined values and indicate that less CO₂ is released from the gas source when the liquid is at a temperature less than 45° F. and that more CO₂ is released from the gas source when the liquid is at a temperature greater than 45° F.

TABLE 2

| 6 oz. CO₂ | 40° F. | 45° F. | 50° F. |
|---|---|---|---|
| Consumption | (g) | (g) | (g) |
| Low | 1.54 − x | 1.54 | 1.54 + a |
| Medium | 2 − y | 2 | 2 + b |
| High | 2.52 − z | 2.52 | 2.52 + c |

Using the embodiment of Table 2 by way of example, if a 6 oz. beverage at a low carbonation level is formed 904 using liquid at 45° F. as a first beverage in which the gas source is being used, determining 906 the amount of CO₂ in the gas source can include subtracting 1.54 from 410 such that 408.46 g is determined 906 to be the current total amount of CO₂ in the gas source. If the next beverage formed 904 is a 6 oz. beverage at a medium carbonation level using liquid at 45° F., determining 906 the amount of CO₂ in the gas source can include subtracting 2 from 408.46 such that 406.46 g is determined 906 to be the current total amount of CO₂ in the gas source.

Carbonation level and volume can be fixed parameters since the carbonation system can be configured to allow only certain choices of carbonation level and volume. Liquid temperature is not a fixed parameter since any number of temperatures may be possible. It is possible but not practical for all possible temperatures of liquid to be provided in a lookup table. The carbonation system (e.g., a processor thereof) can thus be configured to extrapolate CO₂ release information for a particular liquid temperature based on data that is present in the lookup table. For example, using the embodiment of Table 2 by way of example, if a sensed liquid temperature is 42.5° F. for a 6 oz. beverage at a low carbonation level, halfway between 40° F. and 45° F., the carbonation system can be configured to calculate the appropriate CO₂ release amount that is halfway between the values in the lookup table for 40° F. and 45° F. for a 6 oz. beverage at a low carbonation level.

Referring again to FIG. 9, after the amount of CO₂ in the gas source has been determined 906, the carbonation system (e.g., a processor thereof) determines 908 if the determined 906 amount of CO₂ in the gas source is equal to or less than a predetermined threshold amount. In other embodiments, the determination 908 can be whether the determined 906 amount of CO₂ in the gas source is less than a predetermined threshold amount of CO₂. The predetermined threshold amount of CO₂ is discussed further below.

If the determined 906 amount of CO₂ in the gas source is determined 908 to not be equal to or less than the predetermined threshold amount, then the carbonation system (e.g., a processor thereof) does not cause a notification to be provided 910 that is indicative of the amount of CO₂ remaining in the gas source. The carbonation system remains on standby until a next carbonation process begins and CO₂ is again supplied 902 from the gas source (either the same gas source or another gas source that replaced the gas source, as a user may replace the gas source at any time of the user's choosing) to the mixing chamber.

If the determined 906 amount of CO₂ in the gas source is determined 908 to be equal to or less than the predetermined threshold amount, then the carbonation system (e.g., a processor thereof) causes a notification to be provided 910 that is indicative of the amount of CO₂ remaining in the gas source. The carbonation system then remains on standby until a next carbonation process begins and CO₂ is again supplied 902 from the gas source (either the same gas source or another gas source that replaced the gas source, as a user may replace the gas source at any time of the user's choosing) to the mixing chamber.

As mentioned above, the notification can have a variety of configurations. One or more different types of notifications can be provided 910 as the notification. In some embodiments, the notification indicates the total current amount of CO₂ in the gas source. A user may therefore be fully informed of the gas source's CO₂ level, which may help the user decide when the replace the gas source. Over time, a user may learn from seeing the total current amount of CO₂ in the gas source when a new gas source should be ordered and/or when the gas source should be replaced to maintain the user's preferred quality of carbonation. In some embodiments, the notification indicates a binary condition of whether or not the gas source should be replaced, with or without indicating the total current amount of CO₂ in the gas source. A user may therefore be informed proactively when to replace the gas source.

For example, the notification can include a visual indication by illuminating a light of the carbonation system's user interface. A color of the light may be indicative of the information being communicated by the light's illumination, such as the light changing from one color (e.g., white or another color) to a different color (e.g., orange or another color) to indicate that the gas source needs to be replaced or may need to be replaced soon.

For another example, the notification can include a visual indication on a display screen of the carbonation system's user interface. Text (alpha and/or numerical) and/or a symbol on the display screen can indicate that the gas source needs to be replaced or may need to be replaced soon. The symbol can include, for example, a graphical depiction of a canister with a line thereon or shading therein indicating the gas source's fill level. For another example, the symbol can include a graphical gauge showing current total amount of CO₂ in the gas source with a line pointing to a level on a scale, similar to an automobile's fuel gauge. The text can include, for example, a percentage corresponding to a current total amount of CO₂ in the gas source of the gas source, e.g., 25% indicating that the gas source is 25% full. Another example of text includes a number indicating a predicted number of carbonated beverages that can be formed and dispensed given the current determined 906 gas source fill level. If the carbonation system is configured to dispense beverages of different volumes, a plurality of numbers can be provided with each number corresponding to a different drink volume. In embodiments in which the notification is provided 910 continuously, the number can be configured as a countdown that decreases each time a carbonated beverage is formed and dispensed. Another example of text includes a number indicating a predicted number of days remaining in which carbonated beverages that can be formed and dispensed given the current determined 906 gas source fill level and historical daily usage of the carbonation system. If the carbonation system is configured to dispense beverages of different volumes, a plurality of numbers can be provided with each number corresponding to a different drink volume. In embodiments in which the notification is provided 910 continuously, the number can be configured as a countdown.

For still another example, the notification includes a visual indication on a mechanical gauge showing current total amount of CO₂ in the gas source with a needle pointing to a level on a scale, similar to an automobile's fuel gauge. For yet another example, the notification can include an audible indication provided via a speaker of the carbonation system. The audible indication can be spoken words and/or a beep, a tone sequence, or other non-spoken sound.

For another example, the notification can be a visual indication and/or an audible indication provided via an external device (e.g., a mobile phone, a tablet, a smart watch, etc.), such as via a user interface thereof, that is communicatively coupled with the carbonation system, such as via a Bluetooth or other wireless connection. The notification can be provided via the external device in addition nor or instead of the notification being provided via the carbonation system. The carbonation system can be configured to cause the notification to be provided via the external device similar to how the carbonation system itself can provide the notification as discussed herein. FIG. 7O illustrates one embodiment in which the carbonation system 700 of FIGS. 7A-7C is communicatively coupled with an external device 750, although as mentioned above, other carbonation systems described herein can be similarly communicatively coupled with the external device 750.

As in the embodiment of FIG. 9, the carbonation system can be configured to provide 910 the notification only when the CO₂ amount is determined 908 to be equal to or less than the predetermined threshold amount of CO₂. In other embodiments, the carbonation system can be configured to continuously provide 908 the notification. In such embodiments, the determination 908 of whether the determined 906 amount of CO₂ in the gas source is equal to or less than (or only less than) a predetermined threshold amount of CO₂ is omitted. The notification can be provided 908 continuously only when the carbonation system has power, such as via display screen and/or a light of a powered user interface or can be provided 908 continuously regardless of the carbonation system's power status, such as via a mechanical gauge showing current total amount of CO₂ in the gas source with a needle pointing to a level on a scale.

In some embodiments, the predetermined threshold amount can correspond to an amount of CO₂ remaining in the gas source after which carbonation quality of carbonated fluid formed by the carbonation system will be degraded, e.g., because not enough CO₂ will be supplied to the carbonation system's mixing chamber to achieve a desired level of carbonation. The user may therefore learn via the notification that it is time to replace the gas source currently coupled to the carbonation system to maintain carbonation quality.

In some embodiments, the predetermined threshold amount can correspond to an amount of CO₂ remaining in the gas source where, after a certain number of carbonated fluids are formed by the carbonation system using gas from the gas source, carbonation quality of carbonated fluid formed by the carbonation system will be degraded. The user may therefore learn via the notification that it is time to order a new gas source to have on hand ready for use (and/or to verify that a new gas source is already readily available) because the gas source currently coupled to the carbonation system may need replacing soon to maintain carbonation quality. In such embodiments, the predetermined threshold amount of CO₂ can be, for example, 25% of a total amount of CO₂ in the gas source when the gas source is new, e.g., 102.5 g for a 410 g CO₂ canister, 20 g for a 80 g CO₂ canister, etc.

In some embodiments, the predetermined threshold amount can be a preset threshold based on, for example, a known (e.g., experimentally known) number of carbonated fluids that may be formed with proper carbonation quality given the amount of CO₂ remaining the gas source. For example, the known number of carbonated fluids can be conservatively based on a maximum size (e.g., maximum volume) of a carbonated fluid that the carbonation system can form.

In some embodiments, the predetermined threshold amount can be a variable threshold based on a history of use of the carbonation system. The predetermined threshold amount can thus be based on a particular carbonation system's prior use, which may make the predetermined threshold amount more accurately indicate for the particular carbonation system when the gas source should be replaced. The prior use can be based on information regarding one or more characteristics of carbonated fluids previously formed by the carbonation system. As mentioned above, a carbonation system can be configured to allow user selection of one or more aspects of the carbonation system (e.g., volume of carbonated fluid to be dispensed, carbonation level, etc.). The carbonation system can be configured to store, e.g., in a memory thereof, a history of user selections. The carbonation system can thus be configured to maintain historical data of the carbonation system's use that can be used in predicting future use of the carbonation system as related to predicting how many more carbonated fluids may be formed by the carbonation system given a particular amount of CO₂ determined 906 to remain in the gas source.

For example, the carbonation system can be configured to determine an average selected volume in all prior user selections and determine a number of carbonated fluids having the average selected volume that the carbonation system can form with proper carbonation quality given the gas source's determined 906 CO₂ level. If the determined number of carbonated fluids is equal to or less than a predetermined threshold number, the carbonation system can be configured to set the predetermined threshold amount to the current determined 906 CO₂ level of the gas source. Some users may more frequently select a certain size of beverage, e.g., 4 oz., 6 oz., 8 oz., 16 oz., 24 oz., 32 oz., etc., than other users. Larger sizes typically require more CO₂ to be supplied 902 to the mixing chamber than smaller sizes. Based the predetermined minimum threshold amount on historical volume selection may therefore account for beverage volume preference of particular user(s) of the carbonation system.

In some embodiments, instead of considering all prior use selections, a certain predetermined number of most recent prior user selections can be considered. More recent use of the carbonation system may be more indicative of future use than considering a totality of the carbonation system's prior use.

In some embodiments, instead of considering a number of prior use selections, whether it be all prior use selections or only a certain number of prior use selections, a number of prior user selections in a certain predetermined amount of time can be considered. The amount of time can be, for example, a certain number of days preceding the current day, with or without also including the current day. More recent use of the carbonation system may be more indicative of future use than considering a totality of the carbonation system's prior use.

For another example, the carbonation system can be configured to determine an average carbonation level in all prior user selections (or in a certain predetermined number of prior user selections, or a number of prior user selections in a certain predetermined amount of time) and determine a number of carbonated fluids having the average selected carbonation level that the carbonation system can form with proper carbonation quality given the gas source's determined 906 CO₂ level. If the determined number of carbonated fluids is equal to or less than a predetermined threshold number, the carbonation system can be configured to set the predetermined threshold amount to the current determined 906 CO₂ level of the gas source. Some users may more frequently select for beverages to have more carbonation than other users. Higher levels of carbonation require more CO₂ to be supplied 902 to the mixing chamber than lower levels of carbonation. Based the predetermined minimum threshold amount on historical volume selection may therefore account for beverage carbonation preference of particular user(s) of the carbonation system.

In some embodiments, a first predetermined threshold amount can correspond to an amount of CO₂ remaining in the gas source where, after a certain number of carbonated fluids are formed by the carbonation system, carbonation quality of carbonated fluid formed by the carbonation system will be degraded, and a second predetermined threshold amount can correspond to an amount of CO₂ remaining the gas source after which carbonation quality of carbonated fluid formed by the carbonation system will be degraded. The carbonation system can be configured to provide 910 a first notification in response to the first predetermined threshold amount being met, which may provide a warning to the user that the gas source may need to be replaced soon to maintain carbonation quality of carbonated fluids formed by the carbonation system. The carbonation system can be configured to provide 910 a second notification in response to the second predetermined threshold amount being met, which may provide a warning to the user that the gas source should now be replaced to maintain carbonation quality of carbonated fluids formed by the carbonation system. In such embodiments, the determination 908 of whether the amount of CO₂ in the gas source is equal to or less than (or only less than) the predetermined threshold amount can include comparison of the determined 906 amount of CO₂ with each of the first and second predetermined threshold amounts. In some instances, only the second predetermined threshold amount may be compared with the determined 906 amount of CO₂ because if the determined 906 amount of CO₂ is equal to or less than the second predetermined threshold amount it is also necessarily equal to or less than the first predetermined threshold amount.

In some embodiments, determining 908 that the amount of CO₂ is equal to or less than (or only less than) the predetermined threshold amount can trigger the carbonation system (e.g., a processor thereof) to cause an order to be placed ordering a new gas source. A user may be able to choose to opt in or opt out of such automatic reordering. For example, the carbonation system can be configured to communicate over a network to place an online order with a predetermined merchant for a predetermined type of gas source. For another example, the carbonation system can be configured to transmit an instruction to an external device (e.g., a mobile phone, a tablet, a smart watch, etc.) that is communicatively coupled with the carbonation system, such as via a Bluetooth or other wireless connection, to place the order similar to that discussed above. FIG. 7O illustrates one embodiment in which the carbonation system 700 of FIGS. 7A-7C is communicatively coupled with an external device 750, although as mentioned above, other carbonation systems described herein can be similarly communicatively coupled with the external device 750.

In some embodiments, when a gas source is newly coupled to a carbonation system, a user provides a manual input to the carbonation system, e.g., via the carbonation system's user interface or via an external device communicatively coupled with the carbonation system, indicating that a new gas source has been coupled to a carbonation system. In other embodiments, when a gas source is newly coupled to a carbonation system, the carbonation system is configured to automatically detect that a gas source has been coupled to the carbonation system. The automatic detection of the gas source coupling can be achieved in a variety of ways, such as by using a microswitch configured to detect a gas source in the carbonation system's gas source chamber, by a weight sensor configured to sense a weight of a gas source thereon, etc. Whether manually or automatically informed of a newly coupled gas source, the carbonation system can thus be made aware that the current gas source fill level is 100% and make subsequent CO₂ amount determinations 906 accordingly, e.g., starting from a fill level of 100%.

### Venting Systems

In some embodiments, methods, systems, and devices for venting a chamber in a carbonation system are provided. As mentioned above, the methods, systems, and devices can be implemented in treatment systems similar to the carbonation systems described herein except instead of mixing CO₂ with a liquid, a different gas is mixed with the liquid.

In some embodiments, a carbonation system configured to vent a chamber in a carbonation system can also be configured to determine an amount of CO₂ in a gas source, as discussed above, and/or to selectively release CO₂ from a gas source, as discussed above.

In general, a carbonation system can include a venting system configured to vent a mixing chamber of the carbonation system in which a carbonated fluid is configured to be formed. The carbonated fluid is formed in the mixing chamber with pressure in the chamber being higher (e.g., significantly higher) than atmospheric pressure due to the use of a pressurized gas (carbon dioxide) in forming the carbonated fluid. If the carbonated fluid is dispensed from the chamber and out of the carbonation system while the pressure in the chamber is too high above atmospheric pressure, the carbonated fluid will flow too quickly out of the chamber and spray out of the carbonation system, which causes messy splatter and/or causes at least some of the carbonated fluid to not be neatly dispensed into the container. Alternatively, a valve configured to enable opening against the high chamber pressure may be used, but such a valve may require an expensive and high-power actuator, which, in addition to adding cost, may materially disadvantage the function of a carbonation system.

To address this potential problem, an amount of pressure may be vented from the chamber before beginning to dispense the carbonated fluid. However, when venting pressure from the mixing chamber, a sharp pressure drop can cause carbonation loss in the carbonated fluid, thereby reducing the carbonation level from its desired level. The venting system is configured to reduce an extent of such pressure drops and may thereby improve carbonation retention in the carbonated fluid. In exemplary implementations, the venting system is configured to provide flow restriction (also referred to herein as “vent restriction”) configured to provide a restriction on a vent flow path, which may reduce an extent of such pressure drops.

After a carbonated fluid has been formed in the mixing chamber, larger bubbles of CO₂ will rise or float faster than smaller bubbles of CO₂ into a headspace of the chamber that is above the carbonated fluid. If venting of the chamber occurs too soon and/or too much after the carbonated fluid is formed, the carbonated fluid will suffer carbonation loss due to growth of small bubbles still present in the body of the carbonated fluid. Bubble growth may result in the carbonated fluid having less carbonation than desired and expected by a user.

Venting the mixing chamber toward atmospheric pressure can include a first venting period followed by a second venting period. In the first venting period, venting can occur through a vent flow path configured to provide flow restriction. In the first venting period, larger bubbles of CO₂ in the chamber's headspace can be vented out of the chamber while giving time for smaller bubbles to rise or float into the headspace. Some smaller bubbles may also be vented in the first venting period, as some smaller bubbles may have risen or floated in the headspace. The first venting period can begin after a rest period of a predetermined period of time (e.g., two seconds or other period of time) has passed from an end of liquid and gas mixing, e.g., an end of agitator rotation. The rest period can be defined by a time between an end of agitation and a start of venting, or a time between an end of gas injection into the mixing chamber or any other carbonation method and a start of venting. Alternatively, an end of the rest period can be defined by a time at which mixing chamber pressure falls below a saturation pressure of the carbonated fluid, which occurs at a specific point in the venting process. Thus, in some embodiments the rest period and the venting period may overlap, and in other embodiments the rest period and the venting period may be sequential. Waiting the period of time before starting to vent the chamber can reduce a number of residual bubbles within the carbonated fluid at the point where fluid pressure drops below a saturation pressure of the carbonated fluid and can allow larger bubbles of CO₂ to already be the headspace when venting begins. Subsequently, in the second venting period, venting can occur through a vent flow path that does not provide flow restriction. Thus, in the second venting period, faster venting of the chamber can occur than in the first venting period. Carbonation loss in the carbonated fluid may therefore be reduced, as compared to a venting process that does not use a flow restrictor.

In some embodiments, a venting system of a carbonation system that is in fluid communication with the carbonation system's mixing chamber includes a first vent flow path and a second vent flow path. The first vent flow path includes a flow restrictor configured to provide flow restriction. The second vent flow path does not include the flow restrictor and is not configured to provide flow restriction. Venting of the mixing chamber can include venting through the first flow path in a first venting period and then venting through the second flow path in a second venting period.

One embodiment of a venting system that includes a first vent flow path and a second vent flow path is illustrated in FIG. 4. As mentioned above, the venting system of the carbonation system 400 illustrated in FIG. 4 includes the first vent solenoid valve 434, the second vent solenoid valve 420, the flow restrictor 436, and the PRV 422. The venting system in this illustrated embodiment also includes a first T-joint 438, a second T-joint 440, and a third T-joint 442. Open/close positions of the first and second vent solenoid valves 434, 420 and the PRV 422 define through which flow path venting can occur. A processor of the carbonation system 400 is configured to be operably coupled to the first and second vent solenoid valves 434, 420 and the PRV 422 and control their open/close positions.

The first vent flow path from the mixing chamber 404 includes flow through the flow restrictor 436 and the first vent solenoid valve 434. The first vent flow path also includes flow through the first, second, and third T-joints 438, 440, 442. The first vent flow path exits to a drip tray 444 of the carbonation system 400, which may allow for clean collection of excess moisture.

The flow restrictor 436 is configured to restrict flow of gas out of the mixing chamber 404 to allow for a lower vent flow through the first vent flow path than through the second vent flow path. The flow restrictor 436 can include tubing having a smaller diameter compared to tubing along a remainder of the first flow path and to tubing along the second flow path. Thus, fluid flow along the first vent flow path will be reduced as the flow encounters the reduced diameter portion of the first flow path, e.g., as the flow pass through the flow restrictor 436.

The second vent flow path from the mixing chamber 404 includes flow through the second vent solenoid valve 420. The second vent flow path also includes flow through the first, second, and third T-joints 438, 440, 442. The second vent flow path exits to the drip tray 444, which may allow for clean collection of excess moisture.

The venting system in this illustrated embodiment also includes a third flow path from the mixing chamber 404. The third flow path includes flow through the PRV 422. The third vent flow path also includes flow through the first T-joint 438. The third vent flow path exits to the drip tray 444, which may allow for clean collection of excess moisture.

The third flow path is configured as an emergency vent flow path through which venting of the chamber 404 can occur in response to occurrence of an emergency condition. The processor of the carbonation system 400 is configured to open flow through the third flow path, e.g., by controlling open/close position of the first and second vent solenoid valves 434, 420 (each closed when flow through the third flow path is possible) and the PRV 422 (open when flow through the third flow path is possible), in response to occurrence of the emergency condition. For example, the emergency condition can include pressure within the chamber 404 equaling or exceeding a predetermined maximum threshold pressure. The pressure within the chamber 404 can be measured, for example, using a pressure sensor (not shown in FIG. 4) communicatively coupled with the processor.

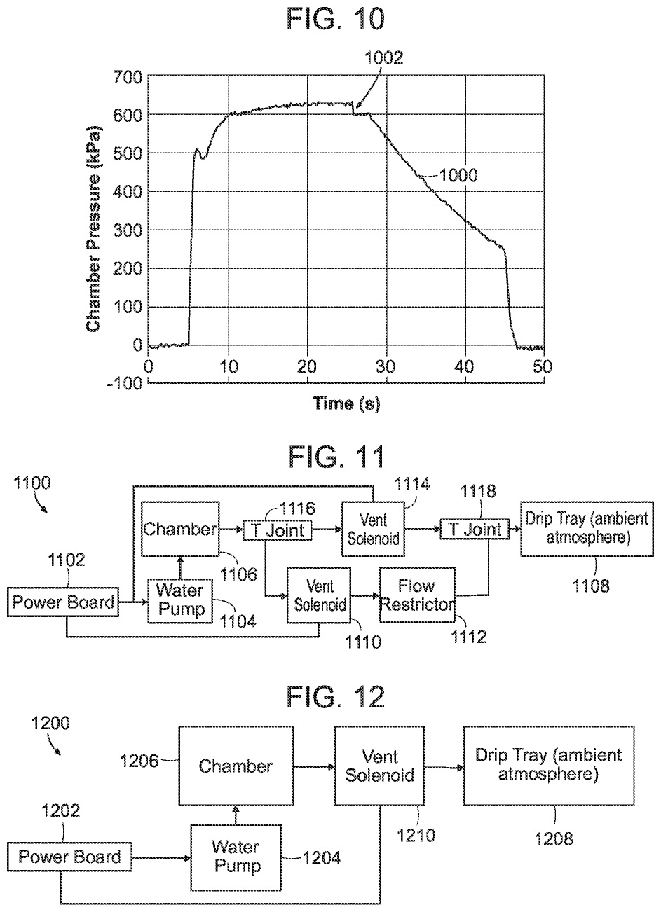

FIG. 10 shows a graph illustrating one embodiment of chamber pressure versus time. A plot line 1000 in the graph is one example of a restricted flow that may be achieved using a venting system including a first vent flow path and a second vent flow path such as the first and second vent flow paths of the venting system of FIG. 4. As shown by the plot line 1000, CO₂ begins being added to the mixing chamber 404 at about time=5 seconds, and mixing of liquid in the chamber 404 with the CO₂ in the chamber 404 occurs until about time=26 seconds, at which time the plot line 1000 shows the gas pressure in the chamber 404 being substantially constant at about 600 kPa until about time=28 seconds. A person skilled in the art will appreciate that a value may not be precisely at a value but nevertheless considered to be about that value due to any number of factors, such as sensitivity of measurement equipment. The first vent flow path opens at about time=28 seconds. In this illustrated embodiment there is thus about a two second wait time between an end of mixing and a start of venting, which as mentioned above can allow larger bubbles to rise or float to the headspace of the mixing chamber 404. Venting occurs through the first vent flow path for a short amount of time, as indicated by the plot line 1000 moving downward (shown at a line portion 1002), before the vent flow path changes from the first vent flow path to the second vent flow path. Pressure therefore decreases in the chamber 404 until about time=46 seconds, when the carbonated fluid in the chamber 404 begins being dispensed from the chamber 404 to the cup (or other container) and the pressure in the chamber 404 drops to about zero.

Another embodiment of a carbonation system's venting system that includes a first vent flow path and a second vent flow path is illustrated in FIG. 11. The carbonation system 1100 of FIG. 11 is generally configured and used similar to the carbonation systems discussed herein but is shown in simplified form in FIG. 11. As shown in FIG. 11, the carbonation system 1100 includes the venting system, a power board 1102 (e.g., a printed circuit board including a processor and other electronic components), a liquid pump 1104 (which is a water pump in this illustrated embodiment), a mixing chamber 1106, and a drip tray 1108. As also shown in FIG. 11, the venting system includes a first vent solenoid 1110, a flow restrictor 1112, and a second vent solenoid 1114. The venting system in this illustrated embodiment also includes a first T-joint 1116 and a second T-joint 1116. Open/close positions of the first and second vent solenoids 1110, 1114 define through which flow path venting can occur. As shown in FIG. 11, the power board 1102, e.g., the processor thereof, is configured to be operably coupled to the first and second vent solenoids 1110, 1114 and control their open/close positions.

The first vent flow path from the mixing chamber 1106 includes flow through the first vent solenoid valve 1110 and the flow restrictor 1112. The flow restrictor 1112 is configured similar to that discussed above regarding the flow restrictor 436 of FIG. 4. The first vent flow path also includes flow through the first and second T-joints 1116, 1118. The first vent flow path exits to the drip tray 1108, which may allow for clean collection of excess moisture. In this illustrated embodiment, the first vent flow path is through the first vent solenoid valve 1110 before the flow restrictor 1112, unlike the first flow path of FIG. 4 in which the first vent flow path is through the flow restrictor 436 before the first vent solenoid valve 434.

The second vent flow path from the mixing chamber 1106 includes flow through the second vent solenoid 1114. The second vent flow path also includes flow through the first and second T-joints 1116, 1118. The second vent flow path exits to the drip tray 1108, which may allow for clean collection of excess moisture.

The carbonation system 1100 of FIG. 11 as shown does not include a vent flow path for emergency flow but can include such a vent flow path similar to that discussed above regarding FIG. 4.

The plot line 1000 of FIG. 10 is also an example of a restricted flow that may be achieved using the first and second vent flow paths of the carbonation system 1100 of FIG. 11.

In some embodiments that include a first vent flow path and a second vent flow path, such as the embodiments illustrated in FIGS. 4 and 11, flow through the first vent flow path, without flow through the second flow path, occurs in a first venting period and flow through the second vent flow path, without flow through the first flow path, occurs in a second venting period. Restricted flow may thus be achieved as discussed herein by allowing flow through the first flow path and subsequently allowing flow through the second flow path. In other embodiments, that include a first vent flow path and a second vent flow path, such as the embodiments illustrated in FIGS. 4 and 11, flow through the first vent flow path, without flow through the second flow path, occurs in a first venting period and flow through the first and second vent flow paths occurs in a second venting period. Restricted flow may thus be achieved as discussed herein by allowing flow through the first flow path and subsequently allowing flow through both of the first and second flow paths.

In other embodiments, a venting system of a carbonation system that is in fluid communication with the carbonation system's mixing chamber includes a single vent flow path. The single vent flow path is configured to selectively provide flow restriction. Venting of the mixing chamber can include pulsed or modulated venting through the single flow path in a first venting period and then non-pulsed venting through the single flow path in a second venting period. The single flow path can thus provide functionality similar to the first and second vent flow paths discussed above but achieve such functionality with fewer components and thus with less cost and/or less real estate occupied in the carbonation system by the venting system.

One embodiment of a carbonation system's venting system that includes a single vent flow path is illustrated in FIG. 12. The carbonation system 1200 of FIG. 12 is generally configured and used similar to the carbonation systems discussed herein but is shown in simplified form in FIG. 12. As shown in FIG. 12, the carbonation system 1200 includes the venting system, a power board 1202 (e.g., a printed circuit board including a processor and other electronic components), a liquid pump 1204 (which is a water pump in this illustrated embodiment), a mixing chamber 1206, and a drip tray 1208. As also shown in FIG. 12, the venting system includes a vent solenoid 1210. The vent flow path from the mixing chamber 1206 includes flow through the vent solenoid valve 1210. The vent flow path exits to the drip tray 1208, which may allow for clean collection of excess moisture.

As shown in FIG. 12, the processor of the carbonation system 1200 is configured to be operably coupled to the vent solenoid valve 1210 and control the vent solenoid valve's open/close position. In a first venting period, the processor is configured to cause the vent solenoid valve 1210 to repeatedly and quickly open and close so as to provide a pulsed vent flow through the vent flow path in which venting quickly starts (vent flow path open) and stops (vent flow path closed). In a second venting period, the processor is configured to cause the vent solenoid valve 1210 to be open continuously such that the vent flow path is open continuously. The pulsed venting in the first flow period is configured to provide a restricted flow since the flow is less than the flow is with the vent solenoid valve 1210 open continuously. Pulsed venting is not necessary in the embodiments discussed above in which a venting system includes first and second vent flow paths because each flow path defines a different flow rate therethrough due to the presence of a flow restrictor (first vent flow path) or absence of a flow restrictor (second vent flow path). Instead of the processor being configured to cause the vent solenoid valve 1210 to repeatedly and quickly open and close so as to provide a pulsed vent flow, the carbonation system 1200 can include a vent valve with a proportional opening. The vent valve is configured to adjust an effective flow resistance in the vent path. In such embodiments, the processor is configured to set the valve opening position to provide a small aperture for the first venting period so as to provide a high flow resistance through the vent valve. In the second venting period, the processor is configured to set the valve opening position to a larger aperture so as to provide a lower flow resistance through the vent valve than in the first venting period. Proportional aperture valves of different types can be used as the vent valve.

A plot line showing restricted flow that may be achieved using a venting system including a single vent flow path, such as the single flow path of the venting system of FIG. 12, is similar to the plot line 1000 of FIG. 10. However, for a single vent flow path, the pressure during the first period of time would not be shown a substantially straight line as shown by the line portion 1002 of FIG. 10. Instead, the pressure during the first period of time would have repeated small decrements, similar to a staircase, representing the repeated opening and closing of the single vent solenoid valve 1210.

The carbonation system 1200 of FIG. 12 as shown does not include a vent flow path for emergency flow but can include such a vent flow path similar to that discussed above regarding FIG. 4. In such a case, the venting system still includes a single vent flow path for normal use of the carbonation system 1200, as opposed to the venting systems of FIGS. 4 and 11 that each include two vent flow paths for normal use.

Other embodiments of venting systems that include a single vent flow path are illustrated in FIGS. 1-3. As discussed above, the venting system of FIG. 1 includes a single vent solenoid 120, the venting system of FIG. 2 includes a single vent solenoid 220, and the venting system of FIG. 3 includes a single vent solenoid 322. The venting systems of FIGS. 1-3 can thus be configured to provide a restricted flow similar to that discussed above regarding FIG. 12, although any of these venting systems may be used without providing a restricted flow, e.g., venting occurs without any pulsing. FIGS. 1-3 also illustrate venting systems each including an emergency vent flow path, with the venting system of FIG. 1 including the PRV 122, the venting system of FIG. 2 including the PRV 222, and the venting system of FIG. 3 including the PRV 324.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, algorithm, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code).

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices). The processor and the memory can be supplemented by, or incorporated in, special purpose logic circuitry.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor). The modules described herein can be combined, integrated, separated, and/or duplicated to support various applications. Also, a function described herein as being performed at a particular module can be performed at one or more other modules and/or by one or more other devices instead of or in addition to the function performed at the particular module.

One skilled in the art will appreciate further features and advantages of the devices, systems, and methods based on the above-described embodiments. Accordingly, this disclosure is not to be limited by what has been particularly shown and described, except as indicated by the appended claims. All publications and references cited herein are expressly incorporated herein by reference in their entirety for all purposes.

The present disclosure has been described above by way of example only within the context of the overall disclosure provided herein. It will be appreciated that modifications within the spirit and scope of the claims may be made without departing from the overall scope of the present disclosure.

What is claimed is:

1. A system comprising:
a chamber configured to receive a liquid and a pressurized gas therein that are mixed together in the chamber to form a treated fluid;
one or more vents operatively coupled to the chamber and configured to move from a closed position to an open position so as to allow pressure in the chamber to be released through the one or more vents; and
a processor configured to control movement of the one or more vents between the closed position and the open position such that the release of the pressure occurs in a first venting period, in which flow is restricted through the one or more vents, and then in a second venting period, in which flow is not restricted through the one or more vents.

2. The system of claim 1, wherein the one or more vents include a first vent and a second vent.

3. The system of claim 2, further comprising a flow restrictor configured to be in fluid communication with the first vent;
wherein the flow restrictor is not in fluid communication with the second vent.

4. The system of claim 3, wherein the processor is configured to control movement of the first vent and the second vent such that, in the first venting period, venting of the chamber occurs through the first vent and the flow restrictor, and in the second venting period, venting of the chamber occurs through the second vent.

5. The system of claim 4, wherein in the first venting period venting of the chamber does not occur through the second vent; and
in the second venting period venting of the chamber does not occur through the first vent or the flow restrictor.

6. The system of claim 2, wherein venting of the chamber is configured to occur through only one of the first and second vents at a time.

7. The system of claim 1, wherein the one or more vents include a single vent.

8. The system of claim 7, wherein the processor is configured to control movement of the single vent such that, in the first venting period, the single vent is repeatedly opened and closed, and in the second venting period, the single vent remains open continuously.

9. The system of claim 1, wherein the gas is carbon dioxide, and the treated fluid is a carbonated fluid.

10. A method comprising:
forming a treated fluid in a chamber by mixing together a liquid and a gas under pressure; and
after forming the treated fluid, controlling, using a processor, movement of one or more vents between a closed position and an open position such that release of pressure in the chamber occurs in a first venting period, in which flow is restricted through the one or more vents, and then in a second venting period, in which flow is not restricted through the one or more vents.

11. The method of claim 10, wherein the one or more vents include a first vent and a second vent.

12. The method of claim 11, wherein a flow restrictor is in fluid communication with the first vent, and the flow restrictor is not in fluid communication with the second vent.

13. The method of claim 12, wherein the processor controls movement of the first vent and the second vent such that, in the first venting period, venting of the chamber occurs through the first vent and the flow restrictor, and in the second venting period, venting of the chamber occurs through the second vent.

14. The method of claim 13, wherein in the first venting period venting of the chamber does not occur through the second vent; and
in the second venting period venting of the chamber does not occur through the first vent or the flow restrictor.

15. The method of claim 11, wherein venting of the chamber occurs through only one of the first and second vents at a time.

16. The method of claim 10, wherein the one or more vents include a single vent.

17. The method of claim 16, wherein the processor controls movement of the single vent such that, in the first venting period, the single vent is repeatedly opened and closed, and in the second venting period, the single vent remains open continuously.

18. The method of claim 10, wherein the gas is carbon dioxide, and the treated fluid is a carbonated fluid.

19. A method comprising:
forming a treated fluid in a chamber by mixing together a liquid and a gas under pressure; and
after forming the treated fluid, controlling, using a processor, venting of pressure from the chamber such that after a predetermined period of time passes from an end of the mixing together of the liquid and the gas, starting to vent the chamber at a first rate of pressure release in a first venting period and, thereafter, venting the chamber at a second, higher rate of pressure release in a second venting period.

20. The method of claim 19, wherein the processor controlling the venting of pressure includes the processor controlling opening and closing of at least one vent through which pressure is released from the chamber.
